(19) United States
(12) Patent Application Publication
(10) Pub. No.: US 2026/0198542 A1
(43) Pub. Date: Jul. 16, 2026

(54) METHODS OF MAKING, PROTECTING, AND DELIVERING STABLE PREBIOTIC COMPOSITIONS

(71) Applicant: Iowa State University Research Foundation, Inc., Ames, IA (US)

(72) Inventors: Greg Curtzwiler, Ames, IA (US); Mark Lyte, Ames, IA (US)

(21) Appl. No.: 19/131,482

(22) PCT Filed: Nov. 22, 2023
(86) PCT No.: PCT/US2023/080845

§ 371 Date: May 20, 2025

Related U.S. Application Data
(60) Provisional application No. 63/384,826, filed on Nov. 23, 2022.

(51) Int. Cl. A23L 33/135; A23L 29/00

(52) U.S. Cl. CPC A23L 33/135; A23L 29/045; A23L 29/05

(57) ABSTRACT

Compositions providing stable and protected prebiotic to provide a prebiotic delivery system to fortify feed, food or water sources for digestion activation of a dopamine precursor are disclosed. The compositions provide a protectant material and a prebiotic dopamine precursor. Methods of making stable protected prebiotic compositions, methods of delivering a fortified feed, food or water source, and methods of treating subjects with the compositions providing stable and protected prebiotics are also disclosed.

### CROSS REFERENCE TO RELATED APPLICATIONS

This application claims priority under 35 U.S.C. § 119 to provisional patent application U.S. Ser. No. 63/384,826, filed Nov. 23, 2022. The provisional patent application is herein incorporated by reference in its entirety, including without limitation, the specification, claims, and abstract, as well as any figures, tables, appendices, or drawings thereof.

### TECHNICAL FIELD

The disclosure relates generally to compositions providing stable and protected prebiotic to provide a prebiotic delivery system to fortify feed, food or water sources for digestion activation of a dopamine precursor. The disclosure also relates to methods of making stable protected prebiotic compositions, methods of delivering a fortified feed, food or water source, and methods of treating subjects with the same.

### BACKGROUND

Antibiotic-free animal production has necessitated new strategies to mitigate growing occurrences of gut inflammation, which is currently a major economic concern. Feeding strategies to reduce gut inflammation is the number one economic issue facing the poultry, pig, and other production animal and fish industries. Synbiotic combinations of certain probiotics and prebiotics have achieved increased dopamine production capable of reducing gut inflammation. As shown in FIG. 1, use of probiotics including E. faecium is effective in preventing and reducing gut inflammation due to its ability to produce dopamine, an immune modulating neurochemical. Further, E. faecium and L-DOPA synbiotic compositions increase dopamine levels in mice feces compared to the bacteria/supplement controls. However, stable and accurate delivery of the key prebiotic L-DOPA remains a critical challenge and a limitation for use of such synbiotic compositions.

Thus, there exists a need in the art for cost-effective methods to protect, such as through encapsulation, coating, or the like, to provide compositions for delivery of stable encapsulated prebiotics to fortify feed, food, or water sources, namely animal feed, such as shown in FIG. 2. A composition, delivery system and methods to maintain prebiotic/probiotic separation until digestion induced activation upon consumption is needed for adequate commercial use of such an antibiotic free approach to treatment and prevention of gut inflammation and other diseases and conditions.

It is therefore an object of this disclosure to provide stable protected prebiotic compositions, optionally in combination with probiotics, in animal feed to provide a fortified animal feed, food or water source.

It is a further object of this disclosure to provide nutritional dopamine-producing probiotics in combination with L-DOPA coated feed as an additive to animal feed, food or water sources.

It is a further object of the disclosure to provide methods for delivering a fortified feed or food source comprising the stable encapsulated prebiotic compositions and optional probiotic in feed, food or water sources.

It is another object of this disclosure to beneficially be able to fortify and deliver any commercial feed (i.e. provided to animals such as farm production animals), food sources (i.e. provided to humans or in some instances animals) or water sources containing the prebiotic dopamine precursor, namely L-DOPA.

It is yet another object of the disclosure to provide methods for treating a subject that is in need of or desires treatment and/or prevention of inflammation, inflammatory disease states, and/or for improved gut health by delivering a fortified feed, food or water source comprising the stable protected prebiotic compositions.

It is yet another object of the disclosure to provide methods for treating a subject that is in need of or desires treatment and/or prevention of psychological disorders and/or neurodegenerative diseases by delivering a fortified feed, food, or water source comprising the stable protected prebiotic composition.

It is yet a further object of the disclosure to provide compositions and methods to provide biological levels of dopamine for reduction of gut inflammation in the animal production and aquaculture industries. This objective will provide the next generation of functional probiotics for humans and animals, namely the animal production and aquaculture industries.

It is yet a further object of the disclosure to provide compositions and methods that are antibiotic-free.

Other objects, embodiments and advantages of this disclosure will be apparent to one skilled in the art in view of the following disclosure, the drawings, and the appended claims.

### SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

It is a further object, feature, and/or advantage of the present disclosure to provide a composition comprising: a stable protected prebiotic comprising a prebiotic dopamine precursor and/or co-factor of dopamine and a protectant material comprising zein, a natural or synthetic protein comprising tyrosine, a natural or synthetic polymer comprising tyrosine, and/or other natural or synthetic monomers with similar structures to tyrosine; wherein the composition is a prebiotic delivery system that fortifies a feed, food or water source for digestion activation of the dopamine precursor and/or co-factor of dopamine.

It is still yet a further object, feature, and/or advantage of the present disclosure to provide methods of making a stable protected prebiotic composition as described herein, comprising: combining a prebiotic dopamine precursor and/or a co-factor of dopamine and a protectant material to form a stable protected prebiotic, wherein the protectant material comprises zein, a natural or synthetic protein comprising tyrosine, a natural or synthetic polymer comprising tyrosine, and/or other natural or synthetic monomers with similar structures, and wherein the stable protected prebiotic composition is a liquid.

According to additional aspects of the present disclosure, methods of delivering a fortified feed, food or water source comprise: combining the compositions described herein with a feed, food, or water source to provide a fortified feed, food, or water source; and administering to a subject the fortified feed, food, or water source; wherein the composition prevents oxidation of the prebiotic dopamine precursor and/or a co-factor of dopamine prior to delivery into a gut of the subject.

According to some additional aspects of the present disclosure, methods of treating a subject in need of treatment and/or prevention of inflammation, inflammatory disease states, and/or for improved gut health comprises: administering to a subject a therapeutically effective amount of the compositions described herein in combination with a feed, food or water source, wherein the composition protects the prebiotic dopamine precursor and/or a co-factor of dopamine from oxidation prior to delivery into a gut of the subject.

According to additional aspects of the present disclosure, methods of treating a psychological disorder and/or a neurodegenerative disease in a subject in need thereof, comprises: administering to a subject a therapeutically effective amount of the composition described herein in combination with a feed, food or water source, wherein the composition protects the prebiotic dopamine precursor and/or a co-factor of dopamine from oxidation prior to delivery into a gut of the subject

These and/or other objects, features, advantages, aspects, and/or embodiments will become apparent to those skilled in the art after reviewing the following brief and detailed descriptions of the drawings. Furthermore, the present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

While multiple embodiments are disclosed, still other embodiments will become apparent to those skilled in the art from the following detailed description, which shows and describes illustrative embodiments. Accordingly, the drawings and detailed description are to be regarded as illustrative in nature and not restrictive.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows a graph illustrating that feeding a diet supplemented with the probiotic E. faecium plus L-DOPA is proven in vivo to result in increasing levels of dopamine within the gastrointestinal tract as evidence by with increased fecal levels of dopamine.

FIG. 2 shows an exemplary pathway to producing a prebiotic dopamine precursor/probiotic (synbiotic) fortified feed.

FIG. 3 shows a graph quantifying zein size and polydispersity in 80% ethanol solution via dynamic light scattering.

FIG. 4 shows FTIR spectra showing characteristic peaks of L-DOPA (solid line) in the zein/L-DOPA mixture (dash-dot line) not present in the zein spectrum (dot line).

FIG. 5 shows FTIR spectra showing characteristic peaks of gum Arabic (dash dot line), L-DOPA (dot line), and zein (dash-dot line) in the formulated high concentration of L-DOPA/zein/gum Arabic (solid line).

FIG. 6 shows a photograph image showing oxidized levodopa (L-DOPA) in solution without zein (right) and unoxidized levodopa with zein protectant (left).

FIG. 7 shows a graph of dopamine content measured in cecal contents across groups of mice evaluated at time of sacrifice as described in Example 2.

FIG. 8 shows a graph of dopamine content measured in cecal tissue across groups of mice evaluated at time of sacrifice as described in Example 2.

FIG. 9 shows a graph of dopamine content measured over 9 days across groups of mice evaluated in Example 2.

FIG. 10 shows a graph of dopamine content measured at day 6 and day 8 across groups of mice evaluated in Example 2.

FIG. 11 shows a graph of L-DOPA content measured at day 0 compared to day 4 across groups of mice evaluated in Example 2 assessing differences in degradation of L-DOPA.

FIG. 12 shows a graph of dopamine content measured over 50 hours in the in vitro testing described in Example 3. Group 1 is BHI control, group 2 is BHI+ethanol control, group 3 is zein solution A (0.1%), group 4 is zein solution B (0.1%), group 5 is zein solution oxidized (0.1%), and group 6 is zein solution C (0.1%).

FIG. 13 shows a graph of dopamine content measured over 24 hours in the in vitro testing described in Example 3. Groups 1 is L-DOPA/Zein control with no Lactiferm® or feed, group 2 is L-DOPA/Zein/Gum Arabic (GA) control with no Lactiferm® or feed, group 3 is L-DOPA/Zein suspension with Lactiferm®, group 4 is L-DOPA/Zein/GA suspension with Lactiferm®, group 5 is L-DOPA/Zein with Lactiferm® and feed, and group 6 is L-DOPA/Zein/GA with Lactiferm® and feed.

FIG. 14 shows a photograph of vials of suspension in the in vitro testing as described in Example 3 after feed was added.

FIG. 15 shows L-DOPA levels measured over 24 hours after various compositions were inoculated with the probiotic E. faecium to quantify L-DOPA.

FIG. 16 shows dopamine levels measured over 24 hours after various compositions were inoculated with the probiotic E. faecium to quantify dopamine production.

FIG. 17 shows UV-Vis spectra data collected between 324 and 1100 nm at 0, 1, 2, 3, 4, 5, and 24 hours as described in Example 8.

FIGS. 18A and 18B show data related to in vitro dopamine production in GA dispersant alternatives. Group 1 is chitosan/GA/L-DOPA, group 2 is zein/GA/L-DOPA, group 3 is polyethylene oxide (PEO)/GA/L-DOPA, group 4 is Tween80/GA/L-DOPA, group 5 is L-DOPA. All groups are in 83% Luria-Bertani (LB) solution with 3.33 ug/ml Lactiferm®. 18A: dopamine quantities at 6 and 24 hours. 18B: percent of L-DOPA utilized for dopamine production.

FIGS. 19A-19P show data related to dopamine concentration from the chicken feeding trials conducted in Example 9. In all figures, group 1 is control with no feed additive, group 2 is zein/GA/0.1% L-DOPA, group 3 is soy/GA/0.1% L-DOPA, group 4 is polyvinylpyrrolidone (PVP)/GA/0.1% L-DOPA, and group 5 is albumin/GA/0.1% L-DOPA.

FIGS. 20A-20N show data related to 3,4-Dihydroxyphenylacetic acid (DOPAC) concentration from the chicken feeding trials conducted in Example 9. DOPAC is a metabolite of dopamine. In all figures, group 1 is control with no feed additive, group 2 is zein/GA/0.1% L-DOPA, group 3 is soy/GA/0.1% L-DOPA, group 4 is polyvinylpyrrolidone (PVP)/GA/0.1% L-DOPA, and group 5 is albumin/GA/0.1% L-DOPA.

FIGS. 21A-21N show data related to homovanillic acid (HVA) concentration from the chicken feeding trials conducted in Example 9. HVA is a metabolite of dopamine. In all figures, group 1 is control with no feed additive, group 2 is zein/GA/0.1% L-DOPA, group 3 is soy/GA/0.1% L-DOPA, group 4 is polyvinylpyrrolidone (PVP)/GA/0.1% L-DOPA, and group 5 is albumin/GA/0.1% L-DOPA.

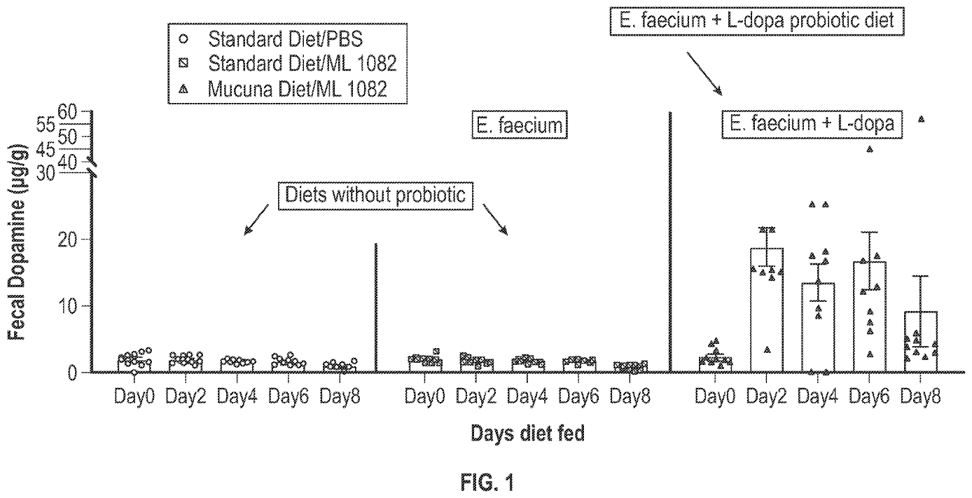

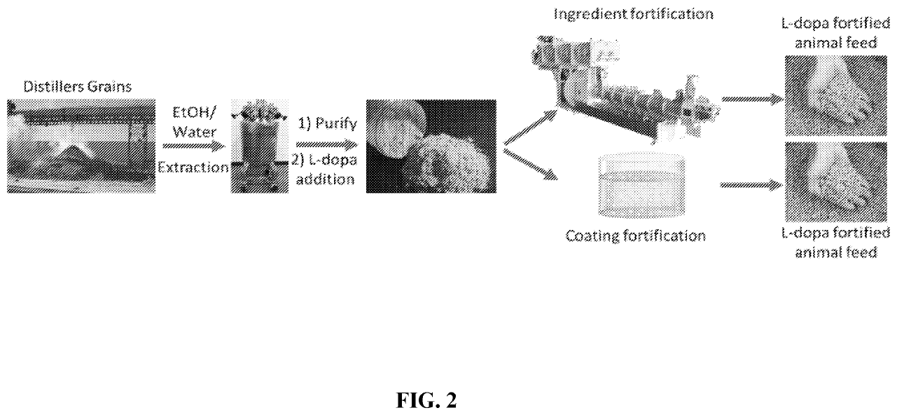

Various embodiments of the present disclosure will be described in detail with reference to the drawings, wherein like reference numerals represent like parts throughout the several views. Reference to various embodiments does not limit the scope of the disclosure. Figures represented herein are not limitations to the various embodiments according to the disclosure and are presented for exemplary illustration of the invention. An artisan of ordinary skill in the art need not view, within isolated figure(s), the near infinite number of distinct permutations of features described in the following detailed description to facilitate an understanding of the present invention.

### DETAILED DESCRIPTION

The present disclosure is not to be limited to that described herein, which can vary and are understood by skilled artisans. No features shown or described are essential to permit basic operation of the present disclosure unless otherwise indicated. It has been surprisingly found that stable and protected prebiotic compositions can provide a prebiotic delivery system to fortify feed, food or water sources for digestion activation of a dopamine precursor.

It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾. This applies regardless of the breadth of the range.

As used herein, the term “and/or”, e.g., “X and/or Y” shall be understood to mean either “X and Y” or “X or Y” and shall be taken to provide explicit support for both meanings or for either meaning, e.g. A and/or B includes the options i) A, ii) B or iii) A and B.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

The methods and compositions of the present disclosure may comprise, consist essentially of, or consist of the components and ingredients of the present disclosure as well as other ingredients described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions.

Unless defined otherwise, all technical and scientific terms used above have the same meaning as commonly understood by one of ordinary skill in the art to which embodiments of the present disclosure pertain.

The terms “invention” or “present invention” are not intended to refer to any single embodiment of the particular invention but encompass all possible embodiments as described in the specification and the claims.

The term “about,” as used herein, refers to variation in the numerical quantity that can occur, for example, through typical measuring techniques and equipment, with respect to any quantifiable variable, including, but not limited to, concentration, mass, volume, time, molecular weight, temperature, pH, molar ratios, and the like. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

As used herein, the term “administering” refers to the placement of a composition into a subject by a method or route which results in at least partial localization of the composition to the gut or other hollow organ (e.g. oral cavity) such that a desired effect is produced. A compound or composition described herein can be administered in a human or animal by any appropriate route known in the art including, but not limited to, oral routes. For example, the compositions may be administered as a lyophilized powder, in a tablet or liquid form. The probiotics may be administered live or heat inactivated dead cells, and in whole or in part. The parts of the probiotic may include cellular components, such as, but not limited to, the DNA or protein which are capable of rendering their beneficial effects.

As used herein, the “alimentary tract” refers to the pathway by which food enters the body of a subject and solid wastes are expelled. The alimentary canal includes, for example, the mouth, pharynx, esophagus, stomach, small intestine, large intestine, and anus.

Terms characterizing sequential order, a position, and/or an orientation are not limiting and are only referenced according to the views presented.

As used herein, an “effective amount” or “therapeutically effective amount” refers to the amount of a compound, such as a prebiotic dopamine precursor that is sufficient to prevent, treat, reduce and/or ameliorate the symptoms and/or underlying causes of a disorder or disease. In an exemplary aspect, an “effective amount” or “therapeutically effective amount” refers to the amount of prebiotic dopamine precursor and/or co-factor of dopamine that is sufficient to prevent, inhibit, and/or treat gut inflammation, promoting health in the gut and/or other therapeutic indications described herein of an animal or human.

As used herein, the term “exemplary” refers to an example, an instance, or an illustration, and does not indicate a most preferred embodiment unless otherwise stated.

The term “generally” encompasses both “about” and “substantially.”

Also, as used herein, the term “gut” refers to the gastrointestinal tract as well as liver, spleen, pancreas, omentum, and other organs served by the blood supply to and from the gut.

“Microorganism” refers to an organism or microbe of microscopic, submicroscopic, or ultramicroscopic size that typically consists of a single cell. Examples of microorganisms include bacteria, viruses, parasites, fungi, certain algae, and protozoa. The term “microbial” indicates pertaining to, or characteristic of a microorganism.

As used herein, the term “Mucuna” is interchangeable with Mucuna puriens, and as such “Mucuna powder” is also interchangeable with Mucuna puriens powder.

As used herein, the term “neurochemical” refers to small organic molecules and peptides that participate in neural, immune and other general physiological activities. Neurochemicals can be produced within in various parts of a subject, such as the gut, brain, etc. Such biogenic neurochemicals are capable of eliciting neural activity. Exemplary neurochemicals include both neurotransmitters and neuromodulators, which can be either excitatory or inhibitor in nature. Exemplary neurochemicals include catecholamines. A further exemplary neurochemical is dopamine.

“Non-pathogenic bacteria” refers to bacteria that under normal conditions do not cause a disease or harmful responses in a healthy host. In some embodiments, non-pathogenic bacteria are commensal bacteria. Examples of non-pathogenic bacteria include, but are not limited to Bacillus spp., Bacteroides spp., Bifidobacterium spp., Brevibacterium spp., Clostridium spp., Enterococcus spp., Escherichia coli. Lactobacillus spp., Lactococcus spp., Saccharomyces spp., and Staphylococcus spp. Naturally pathogenic bacteria may be genetically engineered to provide reduce or eliminate pathogenicity according to standard methods in the art. Non-pathogenic bacteria may be genetically engineered to enhance or improve desired biological properties, e.g., survivability. Non-pathogenic bacteria may be genetically engineered to provide probiotic properties. Probiotic bacteria and/or yeast may be genetically engineered to enhance or improve probiotic properties. Without being limited to a particular mechanism, probiotics differ in their ability to produce neurochemicals in the gut of a subject and therefore have differing abilities to treat a subject according to the methods disclosed herein. Non-pathogenic bacteria may be used for probiotic or synbiotic compositions used to treat subjects, while either pathogenic or non-pathogenic bacteria may be used for production of dopamine in media. Pathogenicity, or virulence, of E. faecium may be defined as in the European Food Safety Authority, Scientific Opinion on the safety and efficacy of Oralin® (Enterococcus faecium) as a feed additive for calves for rearing, piglets, chickens for fattening, turkeys for fattening and dogs, EFSA Journal 2014; 12(6):3727, 19 pp. (doi:10.2903/j.efsa.2014.3727) in section 2.1.1.

As used herein the term “polymer” refers to a molecular complex comprised of a more than ten monomeric units and generally includes, but is not limited to, homopolymers, copolymers, such as for example, block, graft, random and alternating copolymers, terpolymers, and higher “x”mers, further including their analogs, derivatives, combinations, and blends thereof. Furthermore, unless otherwise specifically limited, the term “polymer” shall include all possible isomeric configurations of the molecule, including, but are not limited to isotactic, syndiotactic and random symmetries, and combinations thereof. Furthermore, unless otherwise specifically limited, the term “polymer” shall include all possible geometrical configurations of the molecule.

“Prebiotic” is used to refer to a food or dietary supplement that confers a health benefit on a subject associated with modulating a microbiota. Prebiotics in most instances are not drugs, instead functioning due to changes to the resident bacteria either changing the proportions of the resident bacteria or the activities thereof and not functioning because of absorption of the component or due to the component acting directly on the subject. As referred to herein, a prebiotic includes a precursor and/or co-factor to a neurochemical for combined use with a probiotic.

“Probiotic” is used to refer to live, non-pathogenic microorganisms, e.g., bacteria or fungi, which can confer health benefits to a host organism that contains an appropriate amount of the microorganism. In some embodiments, the host organism is a mammal. In some embodiments, the host organism is a human. In other embodiments, the host organism is an aquaculture species. Some species, strains, and/or subtypes of non-pathogenic bacteria and yeast are currently recognized as probiotics.

The term “sample,” as used herein, refers to any sample suitable for analyzing or typing according to the methods of the present disclosure. A sample may be collected from a subject organism (e.g., human or animal, including fish) and can be in any form, including without limitation a solid material such as a tissue, cells, a cell pellet, a cell extract, or a biopsy, or a biological fluid such as urine, blood, stool, saliva, amniotic fluid, exudate from a region of infection or inflammation, or the like.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

As used herein. “substantially free” may refer to any component that the composition lacks or mostly lacks. When referring to “substantially free” it is intended that the component is not intentionally added to compositions. Use of the term ‘substantially free” of a component allows for trace amounts of that component to be included in compositions of the invention because they are present in another component. However, it is recognized that only trace or de minimus amounts of a component will be allowed when the compositions is said to be “substantially free” of that component. Moreover, the term if a composition is said to be “substantially free” of a component, if the component is present in trace or de minimus amounts it is understood that it will not affect the effectiveness of the compositions. It is understood that if an ingredient is not expressly included herein or its possible inclusion is not stated herein, the invention composition may be substantially free of that ingredient. Likewise, the express inclusion of an ingredient allows for its express exclusion thereby allowing a composition to be substantially free of that expressly stated ingredient.

The term “surfactant” or “surface active agent” refers to an organic chemical that when added to a liquid changes the properties of that liquid at a surface, including surfaces of nanoparticles.

The term “synbiotic” or “synbiotic composition”, as used herein, refers to combining probiotics and prebiotics in a form of synergism. In a particular aspect, the prebiotics include neurochemicals and its precursors and/or co-factors to be utilized by the probiotic of the synbiotic composition. A synbiotic composition can include a co-formulated composition containing both components and additional functional ingredients required for the delivery thereof. More generally, a synbiotic treatment or method is provided by the delivery of both probiotics and prebiotics to a subject in need thereof, regardless of whether the components are delivered separately to the subject.

As used herein, the term “treat”, “treated”. “treatment”, “treating” or like terms when used with respect to a disease or disorder, refers to a therapeutic or prophylactic treatment that increases the resistance of a subject to development of the disease, that decreases the likelihood that the subject will develop the disease, that increases the ability of a subject that has developed disease to fight the disease (e.g., reduce or eliminate at least one symptom typically associated with the infection) or prevent the disease from becoming worse, or that decreases, reduces, or inhibits at least one function of the pathogen, disease or condition.

By “treatment”, “prevention” or “amelioration” of an adverse condition is meant delaying or preventing the onset of such a disease or disorder, reversing, alleviating, ameliorating, inhibiting, slowing down or stopping the progression, aggravation or deterioration the progression or severity of a condition associated with such an adverse condition. In one embodiment, at least one symptom of an adverse condition is alleviated by at least 1%, at least 5%, at least 10%, at least 20%, at least 30%, at least 40%, or at least 50%.

The term “virus”, as used herein refers to a type of microorganism that can include both pathogenic and non-pathogenic viruses. Pathogenic viruses can be classified into two general types with respect to the viral structure: enveloped viruses and non-enveloped viruses. Some well-known enveloped viruses include herpes virus, influenza virus; paramyxovirus, respiratory syncytial virus, corona virus, HIV, hepatitis B virus, hepatitis C virus and SARS-CoV virus. Non-enveloped viruses, sometimes referred to as “naked” viruses, include the families Picomaviridae, Reoviridae, Caliciviridae, Adenoviridae and Parvoviridae. Members of these families include rhinovirus, poliovirus, adenovirus, hepatitis A virus, norovirus, papillomavirus, and rotavirus. It is known in the art that “enveloped” viruses are relatively sensitive and, thus, can be inactivated by commonly used disinfectants. In contrast, non-enveloped viruses are substantially more resistant to conventional disinfectants and are significantly more environmentally stable than enveloped viruses.

As used herein, the term “ware” refers to items such as eating and cooking utensils, dishes, and other hard surfaces such as showers, sinks, toilets, bathtubs, countertops, windows, mirrors, transportation vehicles, and floors. As used herein, the term “warewashing” refers to washing, cleaning, or rinsing ware. Ware also refers to items made of plastic. Types of plastics that can be cleaned with the compositions include but are not limited to, those that include polypropylene polymers (PP), polycarbonate polymers (PC), melamine formaldehyde resins or melamine resin (melamine), acrylonitrile-butadiene-styrene polymers (ABS), and polysulfone polymers (PS). Other exemplary plastics that can be cleaned using the compounds and compositions of the disclosure include polyethylene terephthalate (PET), polystyrene, polyamide (nylon).

The term “weight percent,” “wt-%.” “percent by weight.” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%.” etc.

### Compositions

According to embodiments, the compositions include highly a stable protected prebiotic comprising a prebiotic dopamine precursor and/or a co-factor of dopamine and a protectant material comprising zein, a natural or synthetic protein comprising tyrosine, a natural or synthetic polymer comprising tyrosine, and/or other natural or synthetic monomers with similar structures to tyrosine; wherein the composition is a prebiotic delivery system that fortifies a feed, food or water source for digestion activation of the dopamine precursor and/or co-factor of dopamine. In embodiments the composition is a solid or liquid dosage form.

While the components may have a percent actives of 100%, it is noted that Table 1, does not recite the percent actives of the components, but rather, recites the total weight percentage of the raw materials (i.e. active concentration plus inert ingredients) in either a solid or liquid composition.

TABLE 1

| | First | Second | Third |
|---|---|---|---|
| | Exemplary | Exemplary | Exemplary |
| Material | Range wt. - % | Range wt. - % | Range wt. - % |
| Prebiotic dopamine | 0.01-20 | 0.1-20 | 0.1-10 |
| precursor and/or a | | | |
| co-factor of dopamine | | | |
| Protectant material | 0.05-30 | 0.5-30 | 0.5-20 |
| Dispersant | 0-20 | 0-20 | 0.1-20 |
| Ethanol / Aqueous | 50-99 | 50-99 | 50-99 |
| Solution | | | |
| Additional Functional | 0-50 | 0-50 | 0.1-50 |
| Ingredients | | | |

### Prebiotic Dopamine Precursor

The compositions comprises a prebiotic dopamine precursor. The prebiotic dopamine precursor is preferably L-3,4-dihydroxyphenylalanine (L-DOPA). The term “L-DOPA” refers synonymously to Levodopa (which is 3,4-dihydroxy-L-phenylalanine), an amino acid precursor of dopamine. L-DOPA is converted to dopamine by DOPA decarboxylase in human and animal species and can cross the blood-brain barrier. When in the brain, L-DOPA is decarboxylated to dopamine and stimulates the dopaminergic receptors, thereby increasing the supply of endogenous dopamine to a subject.

In exemplary embodiments, the prebiotic dopamine precursor L-DOPA is provided from a food and/or dietary supplement source (e.g. herbal and plant extracts), including for example plant foods including broad beans, Mucuna pruriens, Vicia faba, and sources from the genera Phanera, Piliostigma, Cassia, Canavalia, and Dalbergia. In further exemplary embodiments the L-DOPA producing plant is Vicia faba or Mucuna pruriens. Notably, Mucuna pruriens contains relatively high (3-7% dry weight) levels of L-DOPA. In some embodiments, up to 88% of L-DOPA can be extracted from Mucuna pruriens by boiling and soaking for approximately 48 hours. In other embodiments, efficiency of the process can be slightly improved by using approximately 0.25-0.50% sodium bicarbonate. In further exemplary embodiments the L-DOPA producing plant is a genetically engineered L-DOPA producing plant of the genus Nicotiana or a Solanum lycopersicum plant.

In another aspect, the precursor can be provided as the product of another bacterial strain, or of a transformed bacterial strain, or as a co-culture with another strain, or as a pure chemical added, which generates the prebiotic composition. An exemplary precursor may be organisms containing, such as an organism naturally expression or an organism transformed to express, tyrosine hydrolase which can convert tyrosine into L-DOPA. Transforming bacteria using heat shock, electroporation, and particle bombardment is well known in the art. In some embodiments the precursor can be a L-DOPA producing microbe, such as an engineered microbe, e.g. E. coli. In some embodiments the precursor can be a genetically engineered L-DOPA producing plant. In some additional embodiments the precursor can be a commercially-available substance procured as an unpurified or purified substance, including for example, L-DOPA can be procured from Thermo Scientific, TCI America, Spectrum Chemical, and others.

In an aspect, a therapeutically effective amount of a prebiotic dopamine precursor can include from about 0.1 mg/kg, about 10 mg/kg, about 50 mg/kg, about 100 mg/kg, or about 200 mg/kg of prebiotic dopamine precursor, namely L-DOPA. In other aspects, the therapeutically effective amount of a prebiotic dopamine precursor can include from about 0.1 mg/g, about 10 mg/g, from about 0.1 mg/kg, about 10 mg/kg, from about 0.1 mg/ton, about 10 mg/ton, or other volumetric equivalent, based on the feed, food or water source.

### Co-Factor of Dopamine

The compositions can optionally include a co-factor of dopamine. An exemplary co-factor of dopamine includes pyridoxal phosphate (Pyridoxal 5-phosphate, PAL-P, PLP, Vitamin B6 phosphate).

In an aspect, a therapeutically effective amount of a co-factor of dopamine can include from about 0.1 mg/kg, about 10 mg/kg, about 50 mg/kg, about 100 mg/kg, or about 200 mg/kg of co-factor of dopamine. In other aspects, the therapeutically effective amount of the co-factor of dopamine can include from about 0.1 mg/g, about 10 mg/g, from about 0.1 mg/kg, about 10 mg/kg, from about 0.1 mg/ton, about 10 mg/ton, or other volumetric equivalent, based on the feed, food or water source.

### Protectant Material

The compositions comprises a protectant material that protects the prebiotic dopamine precursor and/or a co-factor of dopamine as a prebiotic delivery system until digestion activation of the dopamine precursor and/or co-factor of dopamine. As referred to herein, ‘protects’ includes encapsulating, coating, or otherwise preventing degradation of the prebiotic dopamine precursor and/or co-factor of dopamine until digestion activation. In an exemplary embodiment, the protectant material zein protects the L-DOPA from oxidation, which would occur within hours to days without such protectant material.

The protectant material comprises zein, a natural or synthetic protein comprising tyrosine, a natural or synthetic polymer comprising tyrosine, and/or other natural or synthetic monomers with similar structures to tyrosine. In other embodiments, the protectant material comprises poly(lactic-co-glycolic acid) (PLGA) or polyvinylpyrrolidone. Natural or synthetic monomers with structures similar to tyrosine include, for example, 4-vinyl phenol, vinyl catechol, phenylalanine, tryptophan, serine, threonine, asparagine, glutamine, histidine, and methionine. Beneficially, the protectant material provides an edible and digestible laver.

In embodiments the protectant material is a plant protein zein. Zein is available from multiple sources and available in multiple grades, including for example, commercially available zein can be procured from FloZein Products in food and pharmaceutical grades, as well as TCJ America. Thermo Scientific. Spectrum Chemical, and others. In an optional embodiment, the plant protein zein is derived from dried distillers grain (DDG) or from corn endosperm.

In other embodiments, the protectant material is a natural or synthetic protein comprising tyrosine, a natural or synthetic polymer comprising tyrosine, and/or other natural or synthetic monomers with similar structures to tyrosine. Proteins and polymers comprising tyrosine can have different amino acid profiles and tyrosine content from zein. Such additional or zein alternative protectant materials can include for example, soy protein, pea protein, gluten, poly(lactic-co-glycolic acid) (PLGA), poly(N-vinylpyrrolidone), casein/whey, bovine gelatin, albumin, and the like.

In some embodiments, the protectant material has at least about 0.1 g. 0.2 g, 0.5 g, 1 g. 2, g, 3 g or more of tyrosine per 100 g of the protectant material.

In some embodiments the protectant material can be dissolved, ground, pelletized or otherwise modified before adding into the composition to modify particle size, modify moisture content, increase bioavailability, or the like as will be appreciated by a skilled artisan to be within the scope of the disclosure herein.

### Dispersants

The compositions can optionally include a dispersant to disperse the protectant material in the methods of making the compositions with the stable protected prebiotic.

The dispersant is a material that does not interfere with digestion or bioavailability of the prebiotic and moreover is not toxic to a human or animal.

In embodiments, the dispersant can comprise a synthetic polymer, gum, glycerol, food grade surfactant, or combination thereof. In embodiments exemplary dispersants include gums comprising gum Arabic and/or xanthan gum. In some embodiments a carbohydrate-containing dispersant may be preferred, such as a gum or hydroxyethyl cellulose. Without being limited to a particular mechanism of action, the carbohydrate polymers may beneficially accelerate dopamine production and/or bacteria reproduction.

In embodiments exemplary dispersants include food grade surfactants comprising a nonionic surfactant and/or small molecule surfactants including soy lecithin, glycerol monostearate). Additional exemplary surfactants include for example Tween, preferably Tween-80, a polyethoxylated surfactant, or combinations thereof. In embodiments exemplary dispersants include polymers/proteins, including for example chitosan, poly(alginic acid), gelatin, and block copolymers of poly (ethylene oxide) and poly (propylene oxide).

### Additional Functional Ingredients

The components of the composition can further be combined with various functional components suitable for uses disclosed herein. In some embodiments, the compositions including the prebiotic dopamine precursor and/or a co-factor of dopamine, a protectant material and solvents (or aqueous solution) make up a large amount, or even substantially all of the total weight of the compositions. In other embodiments a dispersant is also included in the compositions. For example, in some embodiments few or no additional functional ingredients are disposed therein.

In other embodiments, additional functional ingredients may be included in the compositions. The functional ingredients provide desired properties and functionalities to the compositions. For the purpose of this application, the term “functional ingredient” includes a material that when dispersed or dissolved in the composition, such as an aqueous solution, emulsion or suspension, provides a beneficial property in a particular use. Some particular examples of functional materials are discussed in more detail below, although the particular materials discussed are given by way of example only, and that a broad variety of other functional ingredients may be used. For example, many of the functional materials discussed below relate to materials used in cleaning. However, other embodiments may include functional ingredients for use in other applications.

In some embodiments, the compositions may include suspending agents, rheology modifiers, surfactants, and other pharmaceutically-acceptable carriers and materials that do not negatively interfere with dopamine production or bioavailability. As referred to herein carriers and materials that do not negatively interfere with dopamine production include food grade additives and materials. For example, liquid preparations may contain conventional additives such as suspending agents, for example sorbitol, syrup, methyl cellulose, hydroxyethylcellulose, glucose syrup, gelatin hydrogenated edible fats; emulsifying agents, for example lecithin, sorbitan monooleate, polysorbate 80, or acacia; non-aqueous vehicles (which may include edible oils), for example almond oil, fractionated coconut oil, oily esters such as glycerine, propylene glycol, or ethyl alcohol; preservatives, for example methyl or propyl p-hydroxybenzoate or sorbic acid, and if desired conventional flavoring or coloring agents.

As used here, the term “pharmaceutically-acceptable carrier” means a pharmaceutically-acceptable material, composition or vehicle, such as a liquid or solid filler, diluent, excipient, manufacturing aid (e.g., lubricant, talc magnesium, calcium or zinc stearate, or steric acid), or solvent encapsulating material, involved in carrying or transporting the subject compound from one organ, or portion of the body, to another organ, or portion of the body. Each carrier must be “acceptable” in the sense of being compatible with the other ingredients of the composition and not injurious to the subject. According to embodiments, the pharmaceutically-acceptable carriers are preferred to further be food grade. Some examples of materials which can serve as pharmaceutically-acceptable carriers and/or food grade carriers include: (1) sugars, such as lactose, glucose and sucrose; (2) starches, such as corn starch and potato starch; (3) cellulose, and its derivatives, such as sodium carboxymethyl cellulose, methylcellulose, ethyl cellulose, microcrystalline cellulose and cellulose acetate; (4) powdered tragacanth; (5) malt; (6) gelatin; (7) lubricating agents, such as magnesium stearate, sodium lauryl sulfate and talc; (8) excipients, such as cocoa butter and suppository waxes; (9) oils, such as peanut oil, cottonseed oil, safflower oil, sesame oil, olive oil, corn oil and soybean oil; (10) glycols, such as propylene glycol; (11) polyols, such as glycerin, sorbitol, mannitol and polyethylene glycol; (12) esters, such as ethyl oleate and ethyl laurate; (13) agar; (14) buffering agents, such as magnesium hydroxide and aluminum hydroxide; (15) alginic acid; (16) pyrogen-free water; (17) isotonic saline; (18) Ringer's solution; (19) ethyl alcohol; (20) pH buffered solutions; (21) polyesters, polycarbonates and/or polyanhydrides; (22) bulking agents, such as polypeptides and amino acids (23) serum component, such as serum albumin, HDL and LDL; (22) C2-C12 alcohols, such as ethanol; and (23) other non-toxic compatible substances employed in pharmaceutical formulations. Wetting agents, coloring agents, release agents, coating agents, sweetening agents, flavoring agents, perfuming agents, preservative and antioxidants can also be present in the formulation. The terms such as “excipient”, “carrier”, “pharmaceutically acceptable carrier” or the like are used interchangeably herein.

These additional ingredients can be pre-formulated with the compositions or added to the feed, food or water source directly.

According to embodiments of the disclosure, the various additional functional ingredients may be provided in a composition in the amount from about 0 wt-% and about 50 wt-%, from about 0.01 wt-% and about 50 wt-%, from about 0.1 wt-% and about 50 wt-%, from about 1 wt-% and about 50 wt-%, from about 1 wt-% and about 30 wt-%, from about 1 wt-% and about 25 wt-%, or from about 1 wt-% and about 20 wt-%. In addition, without being limited according to the disclosure, all ranges recited are inclusive of the numbers defining the range and include each integer within the defined range.

### Methods of Making

The stable protected prebiotic compositions can be made by combining a prebiotic dopamine precursor and/or a co-factor of dopamine and a protectant material to form a stable protected prebiotic.

The combining step can take place in an ethanol/aqueous solution, such as a solution ranging from at least about 50%, 60%, 70%, 80%, 90%, or 95% ethanol/water. The combining is in an ethanol/aqueous solution for solubilizing of the components can also be suspended with additional components for processing, including for example sodium bisulfite and sodium hydroxide.

An optional initial step of extracting zein from dried distillers grains (DDG) can be employed to obtain the protectant material according to an embodiment. For example, a 95% ethanol/water solution is used to solubilize the components with sodium bisulfite (0.5%) and sodium hydroxide (0.25%) under heated conditions of 60° C. for about 2 hours to dissolve the zein.

As referred to herein the methods of making the stable protected prebiotic compositions are not limited according to the order of solubilizing the components into the liquid composition. As one skilled in the art will ascertain from the description herein, the methods can include solubilizing the prebiotic dopamine precursor and/or a co-factor of dopamine in the ethanol/aqueous solution and thereafter adding the protectant material in the solution. In an alternative embodiment, the methods can include solubilizing the protectant material in the ethanol/aqueous solution and thereafter adding the prebiotic dopamine precursor and/or a co-factor of dopamine in the solution. In a still further alternative embodiment, the methods can include dissolving the prebiotic dopamine precursor and/or a co-factor of dopamine into a first solution and dissolving the protectant material into a second solution, and combining the first solution and second solution.

The methods and the compositions can also include a dispersant. If used, the dispersant is preferably added after the protectant material is combined with the prebiotic dopamine precursor and/or a co-factor of dopamine (i.e. after the protectant material interacts with the L-DOPA for protection). In an exemplary embodiment, L-DOPA is slightly soluble in water, and the protectant material zein is effectively insoluble in water. Since high concentrations of ethanol are undesirable and delivering high concentrations of aqueous L-DOPA results in precipitation, dispersants (acting as surfactants and stabilizers) can be included to stabilize the L-DOPA/zein complex as an emulsion.

In some embodiments the methods of making the stable protected prebiotic compositions maintain a pH of about 9 or below to prevent oxidation of the prebiotic dopamine precursor and/or a co-factor of dopamine.

The methods produce a liquid composition, preferably a concentrate liquid. The liquid composition can have a viscosity ranging from between about 0.1 cP to about 10 cP at 20° C., between about 0.1 cP to about 8 cP at 20° C., between about 0.1 cP to about 6 cP at 20° C., between about 0.1 cP to about 5 cP at 20° C., between about 0.1 cP to about 3 cP at 20° C., between about 0.5 cP to about 1.5 cP at 20° C., 0.2 cP to about 2 cP at 20° C. between about 0.5 cP to about 1.5 cP at 20° C., or between about 0.7 cP to about 1 cP at 20° C.

The methods produce a liquid composition having particle sizes ranging from between about 5 nm to about 500 microns.

In further embodiments the liquid composition can be spray dried to provide a flowable powder, or solid granulate material for use.

Beneficially the liquid or dried compositions (i.e. solid) provide a shelf-stable composition comprising the stable protected prebiotic that does not exhibit visual signs of the prebiotic (i.e. L-DOPA) degradation or oxidation, such as changes in color. Degradation and oxidation can further be confirmed by quantitative methods, including for example high-performance liquid chromatography (HPLC) or with UV-Vis spectroscopy, or other known methods. In embodiments the compositions are shelf-stable for at least about one month, at least about three months, at least about six months, or at least about 1 year. As one skilled in the art will ascertain, the compositions can be packaged in a manner used to maintain or enhance shelf-stability, such as for example light proof packaging materials.

### Methods of Delivering and Methods of Use

According to additional aspects of the present disclosure, methods of delivering a fortified feed or food source are a cost-effective and therapeutically effective way to deliver the stable protected prebiotic to provide a fortified feed, food, or water source. Thereafter the fortified feed, food, or water source is administered to a subject. Beneficially, the delivery system and methods prevents oxidation of the prebiotic dopamine precursor and/or a co-factor of dopamine prior to delivery into a gut of the subject.

In some embodiments the composition can further comprise a probiotic. Beneficially, the composition maintains prebiotic and probiotic separation until digestion induced activation upon consumption.

Examples of probiotics that may be delivered with the stable protected prebiotic compositions can include, but are not limited to, Candida spp., Debaryomyces spp., Debaryomyces spp., Enterococcus spp., Kluvyeromyces spp., Kluyveromyces spp., Saccharomyces spp., Yarrowia spp., Bifidobacteria spp., Escherichia coli, Vagococcus spp., Carnobacterium spp., Melissococcus spp. and Lactobacillus spp., e.g., Candida humilis, Debaryomyces hansenii, Debaryomyces occidentalis, Kluyveromyces lactis, Kluyveromyces lodderae, Kluyveromvces marxianus, Saccharomyces cerevisiae, Saccharomyces boulardii, Yarrowia hpolytica, Bifidobacterium bifidum, Enterococcus faecium, Enterococcus foecalis, Enterococcus hirae, Enterococcus casseliflavus, Enterococcus gallinarum, Escherichia coli strain Nissle. Lactobacillus acidophilus. Lactobacillus bulgaricus, Lactobacillus paracasei, Lactobacillus plantarum, Vagococcus fluvaialis (Dinleyici et al., 2014; U.S. Pat. Nos. 5,589,168; 6,203,797; 6,835,376). The probiotic may be a variant or a mutant strain of bacterium (Arthur et al., 2012; Cuevas-Ramos et al., 2010; Olier et al., 2012; Nougayrede et al., 2006).

Various Enterococcus spp., including Enterococcus faecium and Enterococcus hirae, are found in probiotic mixtures as well as in fermentation products. The bacteria are beneficially resistant to gastric juice and bile salts, a trait advantageous when attempting to deliver these organisms as an oral probiotic. Various Vagococcus spp. exhibit similar activity to the Enterococcus spp.

In embodiments, the probiotic is at least probiotic bacterial strain comprising an Enterococcus spp. and/or Vagococcus spp. In preferred embodiments, the probiotic is an Enterococcus spp. comprising E. faecium.

The methods of combining the stable protected prebiotic compositions with the probiotic to form a fortified feed, food, or water source. As one skilled in the art will understand the fortified feed, food, or water source can further include additional feed, food, or water in addition to that provided with the stable protected prebiotic compositions and probiotic.

The methods of delivering a fortified feed, food, or water source can provide a therapeutically effective amount of the probiotic, including from is from about 10² CFU to about 10¹⁶ CFU, from about 10⁴ CFU to about 10¹⁴ CFU, from about 10⁴ CFU to about 10¹² CFU, from about 10⁴ CFU to about 10¹⁰ CFU, or from about 10⁵ CFU to about 10¹⁰ CFU based on the weight of a feed, food or water source, including CFU per g, CFU per kg, CFU per ton f the feed or food source, or CFU per volumetric equivalent of the water source. As referred to herein “CFU” is colony forming units. The CFU per measure of the feed, food or water source (e.g. CFU/g, CFU/kg, CFU/ton or CFU/volumetric equivalent) can vary depending on the preparation of the probiotic by a manufacturer, which can vary according to growth protocols used to product a probiotic.

The methods of delivering a fortified feed, food, or water source provide a therapeutically effective amount of the prebiotic dopamine precursor (i.e. L-DOPA) and/or a co-factor of dopamine, including from about 0.1 mg/g to about 10 mg/g, from about 0.1 mg/kg to about 10 mg/kg, or from about 0.1 mg/ton to about 10 mg/ton, or other volumetric equivalent, based on the weight of a feed, food or water source, including mg per g, mg per kg, mg per ton, or mg/other volumetric equivalent of the feed, food or water source. The dosing for the therapeutically effective amount can vary depending on the preparation of the probiotic by a manufacturer, which can vary according to growth protocols used to product a probiotic.

Depending on a producer's aims and the animal species, supplementation at lower levels may yield an economically desirable cost-benefit ratio. In an aspect, a therapeutically effective amount of prebiotic dopamine precursor (i.e. L-DOPA) and/or a co-factor of dopamine, can include at least about 0.1 mg L-DOPA/kg, from about 0.1 mg L-DOPA/kg to about 5 g L-DOPA/kg, from about 0.1 mg L-DOPA/kg to about 1 g L-DOPA/kg, from about 0.1 mg L-DOPA/kg to about 500 mg L-DOPA/kg, from about 0.1 mg L-DOPA/kg to about 100 g L-DOPA/kg, from about 100 mg L-DOPA/kg to about 1 g L-DOPA/kg, on a per kg basis of the animal feed, food or water source. As described in additional embodiments, the same ranges of the prebiotic dopamine precursor (i.e. L-DOPA) and/or a co-factor of dopamine can be provided on a per gram, per kg, or per liter basis of the animal feed, food or water source. Therapeutic ranges for other prebiotic dopamine precursor and/or co-factors of dopamine will depend on various factors present.

In some embodiments, the prebiotic dopamine precursor is administered together with the probiotic. When administered together, the probiotic may be included in an amount of from about 0 CFU/kg of feed/water to about 10¹⁰ CFU/kg, from about 10⁴ CFU/kg to about 10¹⁰ CFU/kg, from about 10⁵ CFU/kg to about 10¹⁰ CFU/kg, or any range therein, and the prebiotic may be included in an amount of from about 0.1 g/kg to about 100 g/kg, from about 0.1 g/kg to about 50 g/kg, from about 0.1 g/kg to about 30 g/kg, from about 0.1 g/kg to about 20 g/kg, or any range therein. In some embodiments, the prebiotic dopamine precursor is administered alone without a probiotic.

The methods can include any order of combining the stable protected prebiotic compositions with the feed, food or water source and optional probiotic. In some embodiments, the stable protected prebiotic composition is sprayed as a liquid solution onto the feed, food or water source. In other embodiments, the stable protected prebiotic composition is a solid or powder, e.g. dried composition, that is then sprayed onto the feed, food or water source.

As referred to herein the probiotic, when included, can be formulated with a feed or food source. Alternatively, the probiotic can be combined with a feed, food or water source at a point of use or administration to an animal.

The methods provide the fortified feed, food, or water source to a subject. Subjects include an animal, which can further include a human, animal (namely mammals) or fish. A subject may also include any farm production animal, including, but not limited to, pigs, poultry such as, but not limited to, chickens, hens, pigeon, turkeys, other avian species such as, but not limited to ducks, geese, goslings, guinea fowl, ostriches, pigeons, bantams, quails, and pheasants. Farm production animals further include ruminants and non-ruminants, such as cattle, swine, sheep, horses, goats, llamas, alpacas, donkeys, rabbits, and dairy cows. A subject may also include fish which may include both vertebrates and invertebrates, including, but not limited to, catfish, salmon, koi, tilapia, shrimp, prawns, lobster, octopus, oysters, crabs, squid, and mollusks, or any other form of aquaculture. Still further a subject may include a companion animal, including for example, dogs, cats, and horses.

In embodiments, the methods beneficially prevent at least about 90% oxidation of the prebiotic dopamine precursor and/or a co-factor of dopamine until delivery into the gut of the subject (i.e. no more than 10% oxidation).

Beneficially the methods are antibiotic-free.

According to additional aspects of the present disclosure, methods of treating a subject in need of treatment and/or prevention of inflammation, inflammatory disease states, and/or for improved gut health comprising: administering to a subject a therapeutically effective amount of the composition as described herein in combination with a feed, food or water source containing a probiotic, wherein the composition protects the prebiotic dopamine precursor and/or a co-factor of dopamine from oxidation prior to delivery into a gut of the subject, and wherein the composition maintains prebiotic and probiotic separation until digestion induced activation upon consumption.

In an embodiment, the subject is in need of treatment and/or prevention of inflammation, inflammatory disease states, and/or for improved gut health. In embodiments, the subject may be suffering from one or more symptoms of change in animal behavior or behavior state (e.g. anxiety, depression), gut inflammation, fever, fatigue, abdominal pain, abdominal cramping, blood in the stool, reduced appetite, unintended weight loss or weight gain and/or other negative health indicators related thereto any one or more of such symptoms.

In embodiments, the methods treat and/or prevent various gastrointestinal conditions, including for example, ulcers, namely gastric ulcers, diarrhea, inflammatory bowel disease (IBD) and associated symptoms and conditions, feeding conditions causing behavioral abnormalities, enterocolitis-type inflammation, and the like. The methods are also suitable for treatment and prevention of other diseases and conditions associated with the neurochemical dopamine. Still further, the methods of treatment are further suitable for use in treatment and/or maintaining general health and well-being of a subject.

In embodiments, the methods treat, prevent, and/or ameliorate various behavioral and/or psychological conditions, such as anxiety, depression, attention-deficit/hyperactivity disorder (ADHD), addiction, schizophrenia, and/or stress. The methods may also be used in the treatment of neurodegenerative diseases associated with the neurochemical dopamine, such as Parkinson disease, Huntington disease, or Multiple Sclerosis. Without being limited by theory, L-dopa is able to cross the blood-brain barrier while dopamine is not. Thus, delivering L-dopa to a subject in the form of a prebiotic composition of the present disclosure can result in increased production of dopamine in the brain of a subject, thereby ameliorating neurological and/or psychological disorders associated with dopamine.

Beneficially, according to the methods the subject produces biological levels of dopamine to reduce inflammation, treat inflammatory disease states and/or improve gut health.

In an aspect, the methods result in dopamine production in the gut of the subject in the amount of at least about 1 μg/mL (micrograms/mL), at least about 5 μg/mL, at least about 10 μg/mL, at least about 20 μg/mL, at least about 30 μg/mL, at least about 40 μg/mL, at least about 50 g/mL, at least about 60 μg/mL, at least about 70 μg/mL, at least about 80 μg/mL, at least about 90 μg/mL, at least about 100 μg/mL, at least about 110 μg/mL, at least about 120 μg/mL, at least about 130 μg/mL, at least about 140 μg/mL, at least about 150 μg/mL, or greater. In further aspects, the probiotic strains produce the neurochemical in the gut of the subject in the amount of at least about 1 ng/mL to 10 mg/mL.

In further aspects, the methods result in conversion of the prebiotic dopamine precursor into dopamine that is at least about 10%, at least about 20%, at least about 30%, at least about 40%, at least about 50%, at least about 60%, at least about 70%, at least about 80%, at least about 90%, at least about 95%, or about 100% providing highly efficient methods.

As a further benefit, the methods administering the therapeutically effective amount of the compositions and the optional probiotics result in healthier subjects having has an increased body weight and/or muscle weight as compared to a subject not treated with the composition. Beneficially, in the use for treating subjects that are, for example, food production animals or aquaculture, the methods of treatment provide higher yields of the subjects as compared to untreated subjects.

### NUMBERED EMBODIMENTS

1. A composition comprising: a stable protected prebiotic comprising a prebiotic dopamine precursor and/or a co-factor of dopamine; and a protectant material comprising zein, a natural or synthetic protein comprising tyrosine, a natural or synthetic polymer comprising tyrosine, and/or other natural or synthetic monomers with similar structures to tyrosine: wherein the composition is a prebiotic delivery system that fortifies a feed, food or water source for digestion activation of the dopamine precursor and/or co-factor of dopamine.
2. The composition of embodiment 1, wherein the prebiotic dopamine precursor is L-DOPA.
3. The composition of embodiment 1 or 2, wherein the L-DOPA can be provided as an herbal or plant source, optionally a genetically engineered L-DOPA producing plant or microbe, or commercially available substance procured as a purified or unpurified substance.
4. The composition of any one of embodiments 1-3, wherein the L-DOPA producing plant is Vicia faba or Mucuna pruriens, or wherein the genetically engineered L-DOPA producing plant is of the genus Nicotiana or a Solanum lycopersicum plant.
5. The composition of any one of embodiments 1-4, wherein the co-factor of dopamine is pyridoxal phosphate.
6. The composition of any one of embodiments 1-5, wherein the protectant material encapsulates, coats, or otherwise prevents degradation of the prebiotic dopamine precursor and/or co-factor of dopamine until digestion activation.
7. The composition of any one of embodiments 1-6, further comprising a dispersant.
8. The composition of embodiment 7, wherein the dispersant comprises a natural polymer, synthetic polymer, gum, glycerol, food grade surfactant, or combinations thereof.
9. The composition of embodiment 7 or 8, wherein the gum comprises gum Arabic and/or xanthan gum.
10. The composition of embodiment 8, wherein the food grade surfactant comprises a nonionic surfactant.
11. The composition of embodiment 10, wherein the nonionic surfactant comprises Tween, Tween-80, a polyethoxylated surfactant, or combinations thereof.
12. The composition of embodiment 8, wherein the natural polymer comprises chitosan and/or alginic acid.
13. The composition of embodiment 8, wherein the synthetic polymer comprises polyethylene oxide.
14. The composition of any one of embodiments 1-13, wherein the prebiotic dopamine precursor and/or co-factor of dopamine is provided in a therapeutically effective amount of from about 0.1 mg/g to about 10 mg/g, from about 0.1 mg/kg to about 10 mg/kg, from about 0.1 mg/ton to about 10 mg/ton, or volumetric equivalent, based on the weight of the feed, food, or water source.
15. The composition of any one of embodiments 1-14, wherein the protectant material is a plant protein zein, optionally wherein the plant protein zein is derived from dried distillers grain (DDG) or from corn endosperm.
16. The composition of any one of embodiments 1-15, wherein the natural or synthetic protein comprising tyrosine is casein, gluten, whey, gelatin, soy protein, pea protein, and/or albumin.
17. The composition of any one of embodiments 1-16, wherein the composition is a solid or liquid dosage form.
18. A method of delivering a fortified feed, food or water source comprising: combining the composition according to any one of embodiments 1-17 with a feed, food, or water source to provide a fortified feed, food, or water source; and administering to a subject the fortified feed, food, or water source: wherein the composition prevents oxidation of the prebiotic dopamine precursor and/or a co-factor of dopamine prior to delivery into a gut of the subject.
19. The method of embodiment 18, wherein the composition further comprises at least one probiotic.
20. The method of embodiments 18 or 19, wherein the composition maintains prebiotic and probiotic separation until digestion induced activation upon consumption.
21. The method of any one of embodiments 18-20, wherein the subject is a human, animal or fish species.
22. The method of any one of embodiments 18-21, wherein the subject is in need of treatment and/or prevention of inflammation, inflammatory disease states, and/or for improved gut health.
23. The method of any one of embodiments 18-22, wherein the composition comprises a therapeutically effective amount of the prebiotic dopamine precursor and/or a co-factor of dopamine from about 0.1 mg/g to about 10 mg/g, from about 0.1 mg/kg to about 10 mg/kg, from about 0.1 mg/ton to about 10 mg/ton, or volumetric equivalent, based on the weight of the feed, food or water source.
24. The method of any one of embodiments 18-23, wherein there is no more than about 10% oxidation of the prebiotic dopamine precursor and/or a co-factor of dopamine until delivery into the gut of the subject.
25. The method of any one of embodiments 19-24, wherein the probiotic is at least one probiotic bacterial strain comprising an Enterococcus spp. and/or Vagococcus spp., and wherein a therapeutically effective amount of the probiotic strain(s) is from about 10⁴ CFU to about 10¹⁴ CFU based on the weight (CFU/g, CFU/kg, or CFU/ton) or volumetric equivalent of a feed, food or water source.
26. The method of embodiment 25, wherein the Enterococcus spp. comprises E. faecium.
27. The method of any one of embodiments 18-26, wherein the method is antibiotic-free.
28. The method of any one of embodiments 18-27, wherein combining the composition and the feed, food or water source is by spraying the composition as a solid or a liquid solution onto the feed, food or water source.
29. The method of embodiment 28, further comprising drying the sprayed feed or food source.
30. A method of treating a subject in need of treatment and/or prevention of inflammation, inflammatory disease states, and/or for improved gut health comprising: administering to a subject a therapeutically effective amount of the composition according to any one of embodiments 1-17 in combination with a feed, food or water source, wherein the composition protects the prebiotic dopamine precursor and/or a co-factor of dopamine from oxidation prior to delivery into a gut of the subject.
31. The method of embodiment 30, wherein the composition further comprises at least one probiotic.
32. The method of embodiment 30 or 31, wherein the composition maintains prebiotic and probiotic separation until digestion induced activation upon consumption.
33. The method of any one of embodiments 30-32, wherein the subject produces biological levels of dopamine to reduce inflammation, treat inflammatory disease states and/or improve gut health.
34. The method of any one of embodiments 30-33, wherein a subject treated with the composition has an increased body weight and/or muscle weight as compared to a subject not treated with the composition.
35. The method of any one of embodiments 30-34, wherein the subject is a human, animal or fish species.
36. The method of any one of embodiments 31-35, wherein the animal species is poultry, pig or other food production animal, or wherein the fish species is any food aquaculture.
37. A method of treatment of a psychological disorder and/or a neurodegenerative disease in a subject in need thereof, comprising administering to a subject a therapeutically effective amount of the composition according to any one of claims 1-5 in combination with a feed, food or water source, wherein the composition protects the prebiotic dopamine precursor and/or a co-factor of dopamine from oxidation prior to delivery into a gut of the subject.
38. The method of embodiment 37, wherein the composition further comprises at least one probiotic.
39. The method of embodiment 37 or 38, wherein the composition maintains prebiotic and probiotic separation until digestion induced activation upon consumption.
40. The method of any one of embodiments 37-39, wherein the psychological disorder is anxiety, depression, attention-deficit/hyperactivity disorder (ADHD), addiction, schizophrenia, and/or stress.
41. The method of any one of embodiments 37-40, wherein the neurodegenerative disease is Parkinson disease, Huntington disease, or Multiple Sclerosis.
42. A method of making a stable protected prebiotic composition, comprising: combining a prebiotic dopamine precursor and/or a co-factor of dopamine and a protectant material to form a stable protected prebiotic, wherein the protectant material comprises zein, a natural or synthetic protein comprising tyrosine, a natural or synthetic polymer comprising tyrosine, and/or other natural or synthetic monomers with similar structure to tyrosine, and wherein the stable protected prebiotic composition is a liquid.
43. The method of embodiment 42, wherein the combining is in an ethanol/aqueous solution.
44. The method of embodiment 42 or 43, wherein the liquid stable protected prebiotic is spray dried.
45. The method of any one of embodiments 42-44, wherein the prebiotic dopamine precursor is L-DOPA.
46. The method of any one of embodiments 42-45, wherein the composition further comprises a dispersant.
47. The method of embodiment 46, wherein the dispersant comprises a natural polymer, synthetic polymer, gum, glycerol, food grade surfactant, or combinations thereof
48. The method of embodiment 47, wherein the gum comprises gum Arabic and/or xanthan gum.
49. The method of embodiment 47, wherein the food grade surfactant comprises a nonionic surfactant.
50. The method of embodiment 49, wherein the nonionic surfactant comprises Tween, Tween-80, a polyethoxylated surfactant, or combinations thereof.
51. The method of embodiment 47, wherein the natural polymer comprises chitosan and/or alginic acid.
52. The method of embodiment 47, wherein the synthetic polymer comprises polyethylene oxide.

### EXAMPLES

Embodiments of the present disclosure are further defined in the following non-limiting Examples. It should be understood that these Examples, while indicating certain embodiments of the disclosure, are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

### Example 1

Evaluation of a means of fortifying animal feed containing probiotic E. faecium with L-DOPA to produce sufficient biological levels of dopamine for the animal production industry was conducted. Zein encapsulation of L-DOPA was evaluated as a cost-effective, stable, and digestible delivery vehicle enabling formulation via a spray coating capable of fortifying commercial animal feed.

### Materials and Methods

Levodopa was purchased from Tokyo Chemical Co., LTD (Japan). Zein was purchased from Acros Organics (China). Gum Arabic was purchased from Sigma-Aldrich (St. Louis, MO). Histological Grade ethanol (95%) was purchased from Fisher Chemical (Fair Lawn, NJ). All chemicals were used as received. Mouse feed was from Purina. Probiotic was from Chr. Hansen and available as Lactiferm.

### Preparation of Levodopa Feed Additives

Five groups of feed additive were created: Levodopa only, Zein+Levodopa (ZL), Zein+Levodopa with gum Arabic (ZGL), a 3-fold increase in concentration of Zein+Levodopa with gum Arabic (HZGL) compared to ZGL, and a negative control of distilled water only. Levodopa (0.7 g for ZL/control or 2.1 g for HZGL) was dissolved in distilled water at 60° C. (178 mL for ZL or 533 mL for HZGL) stirring vigorously for 30 minutes until the Levodopa was completely dissolved. Ethanol (890 mL or 2.1 L for HZGL) was added to the Levodopa solution and mixed vigorously at room temperature for 10 minutes. Zein powder (2.25 g for ZL or 6.75 g for HZGL) was slowly added to the solution while stirring and was left to stir for an additional 30 minutes. If added, gum Arabic (2.25 g for ZGL or 6.75 g for HZGL) was dissolved in distilled water at 60° C. (225 mL for ZGL or 675 mL for HZGL) stirring vigorously for 30 minutes. The gum Arabic solution was then added drop by drop to their respective zein and levodopa solution over the course of 5 minutes continuously stirring at room temperature and further allowed to stir another 30 minutes prior to vacuum distillation.

### Vacuum Distillation of Levodopa Feed Additives

Vacuum distillation was employed to quickly eliminate ethanol from the solutions prior to adding to the feed and further concentrate the feed additives without high heat to reduce the potential for levodopa oxidation. The levodopa solution from groups ZL, ZGL, and HZGL were individually placed into a flask with stirring, subjected to a vacuum generated by water aspiration, and heated to 45° C. Solutions were removed from the vacuum once their volume reached or dropped below ~200 mL. Distilled water was added to the distilled solutions until total volume was 200 mL.

### Preparing Levodopa Feed

Levodopa fortified mouse feed was prepared by mixing dry mouse feed with each solution at a ratio of 200 mL of levodopa additive or distilled water (negative control) per kilogram of mouse feed using a KitchenAid® Classic mixer set to medium low speeds for approximately 5 minutes to sufficiently incorporate the added solution. Mixed feed was then allowed to dry at 30° C. for 24 hours prior to bagging.

### Animals

Fifty male CF-1 mice (4 weeks of age) were obtained from Charles River Laboratories (Wilmington, MA). Animals were randomly selected and group-housed (2 per cage) under a 12:12 light-dark cycle. Tap water was provided ad libitum. Feed was prepared in the lab 3-5 days before animal arrival. All granulated feed, provided in ceramic containers, was given ad libitum starting upon arrival. Fecal specimens were collected from a clean mouse cage on an alternating daily basis and immediately acidified for ultra-high-performance liquid chromatography (UHPLC) processing. Animals were weighed at the time of fecal collection to monitor weight gain. All procedures were approved by the Iowa State University Institutional Animal Care and Use Committee.

### Tissue Preparation and UHPLC Analysis

Beginning at the start of the 8^{th} day of feeding, 1 ml of blood was collected prior to euthanasia and separated within 20 minutes of collection before acidifying approximately 0.4 ml of serum in 0.1 ml of 2M perchloric acid. Approximately 4 cm of intestinal segments (duodenum, jejunum, ileum, and mid-colon), as well as stomach contents, right lung, and caudate liver, were collected and acidified into a pre-weighed tube containing 1 ml of 0.2M perchloric acid. Cecum was emptied of contents, and both tissue and contents were separately acidified in pre-weighed tubes of 1 ml 0.2M perchloric acid.

Following collections, tubes were returned to the lab and weighed for final tissue weights. Samples were homogenized twice with Omni Bead Ruptor Elite (Omni International) for 30 seconds at 5 m/s, with a 10 second rest between cycles. Samples were subsequently centrifuged at 3000×g at 4° C. for 20 minutes and samples were transferred to vials for dilution and UHPLC analysis while remaining samples were stored at −80° C. UHPLC setup consisted of a Dionex Ultimate 3000 autosampler, pump, and RS electrochemical detector (ThermoFisher Scientific; Sunnyvale, CA). Mobile phase was a buffered 10% acetonitrile procured from ThermoFisher Scientific (Catalog #: NC9777698) and used at a flow rate of 0.6 ml/min on a Hypersil BDS C18 column (150 mm×3 mm×3 μm). Prior to injection, samples were maintained at 4° C., and electrochemical detection was accomplished with a 6041RS glassy carbon electrode set to 400 mV. Data analysis was completed using the Chromeleon software package (version 7.2).

### Results and Discussion

### Zein Characterization

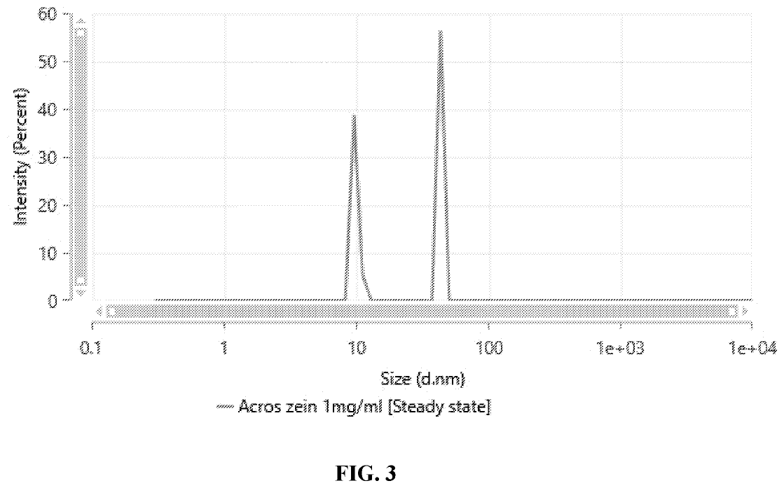

The quantification of zein size and polydispersity in 80% ethanol solution via dynamic light scattering is shown in FIG. 3 with peak area and mean data further shown in Table 2.

TABLE 2

| | | Standard | | Mini- | Maxi- |
|---|---|---|---|---|---|
| Name | Mean | Deviation | RSD | mum | mum |
| Z-Average (nm) | 1201 | — | — | 1201 | 1201 |
| Polydispersity Index | 1 | — | — | 1 | 1 |
| (PI) | | | | | |
| Peak 1 Mean by | 43.68 | — | — | 43.68 | 43.68 |
| Intensity ordered by | | | | | |
| area (nm) | | | | | |
| Peak 1 Area by | 56.08 | — | — | 56.08 | 56.08 |
| Intensity ordered | | | | | |
| by area (%) | | | | | |
| Peak 2 Mean by | 9.846 | — | — | 9.846 | 9.846 |
| Intensity ordered by | | | | | |
| area (nm) | | | | | |
| Peak 2 Area by | 43.92 | — | — | 43.92 | 43.92 |
| Intensity ordered | | | | | |
| by area (%) | | | | | |

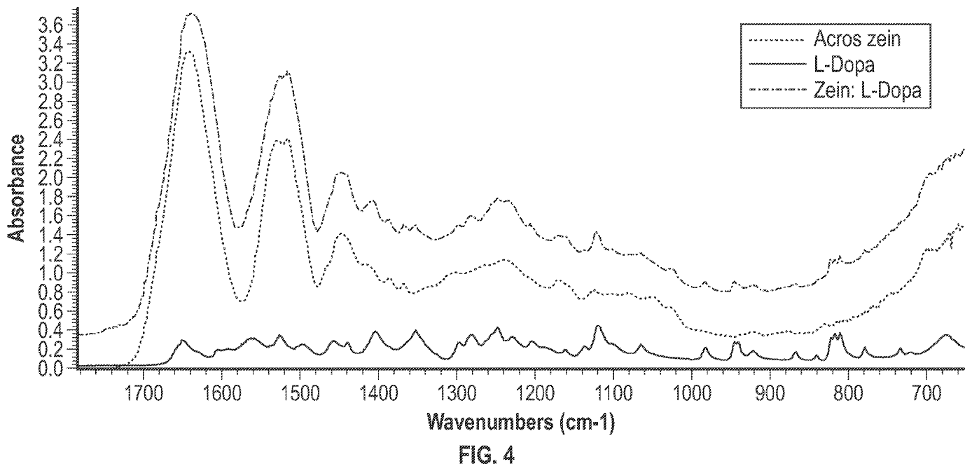

FTIR spectra showing characteristic peaks of L-DOPA (solid line) in the zein/L-DOPA mixture (dash-dot line) not present in the zein spectrum (dot line) is shown in FIG. 4.

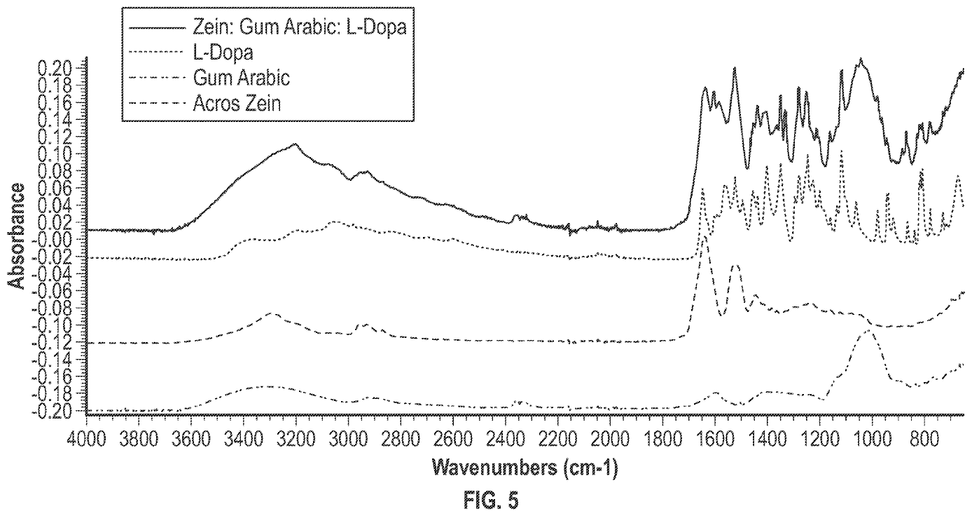

FTIR spectra showing characteristic peaks of gum Arabic (dash-dot line), L-DOPA (dot line), and zein (dash line) in the formulated high concentration of L-DOPA/zein/gum Arabic (solid line) is shown in FIG. 5.

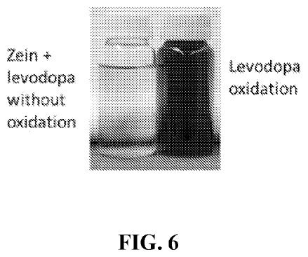

Optical images showing oxidized levodopa in solution without zein (right) and unoxidized levodopa with zein protectant (left) is shown in FIG. 6.

### Example 2

### In Vivo Testing

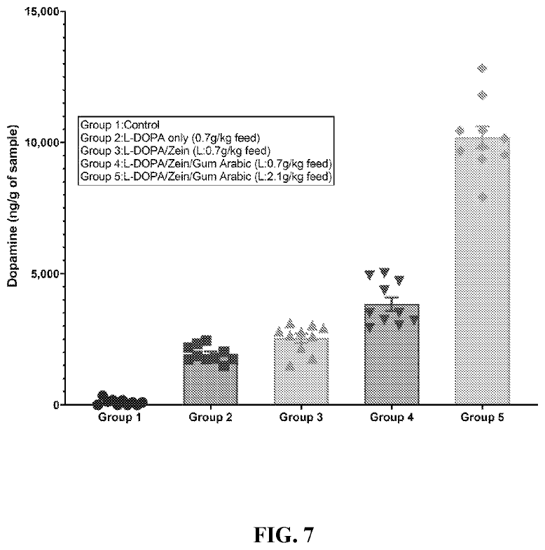

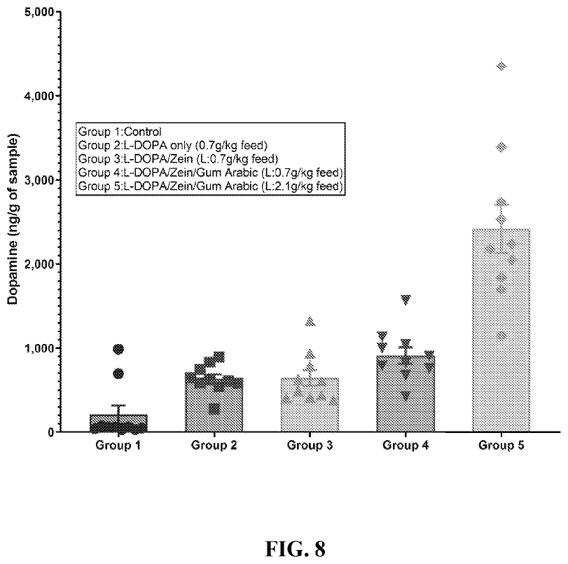

In groups fed a L-DOPA containing diet, there was a noticeable increase in dopamine production throughout the intestinal tract, most notably in the small intestines and cecum. Dopamine production started as early as the duodenum with the greatest production occurring in Groups 3 and 5, groups being fed L-DOPA with zein and no gum Arabic and fed thrice the amount of L-DOPA with zein and gum Arabic, respectively. Within the cecal contents and tissue, FIG. 7 and FIG. 8, respectively, the group with the greatest L-DOPA content had the greatest amount of Dopamine production. However, the 4^{th} group containing the lower amount of L-DOPA with zein and gum Arabic had the next greatest amount and was increased more than any other intestinal segment for that group. This could be an indication that the bacteria have additional efforts to digest the zein protein as well as the gum Arabic. However, it appears that while product digestion and dopamine production begins to occur in the small intestines, the greatest amount of this process occurs in the contents of the cecum.

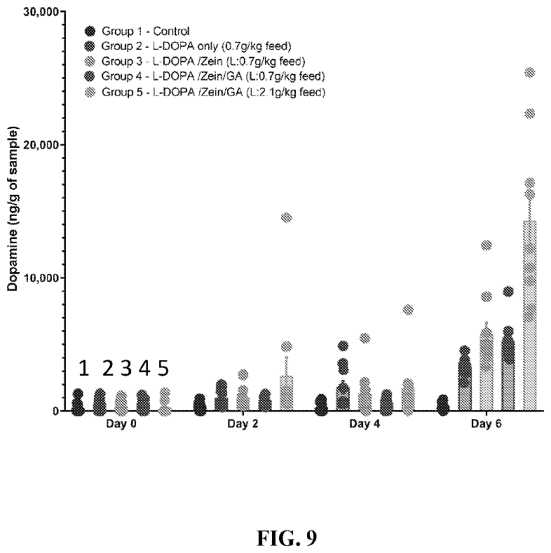

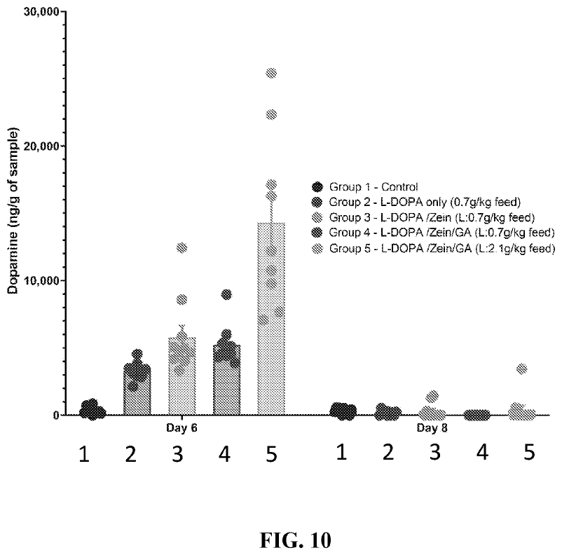

Fecal specimens were collected on an every other day basis. Dopamine production could be noted as early as day 2, however, by day 6 there were significant differences for each group compared to the control group, see FIG. 9. Collection throughout the feeding process was completed by collecting the fecal pellets off of a clean cage bottom. During the necropsy process on Day 8, the fecal pellets were collected after euthanasia and during the necropsy process by opening the colon and removing the pellets nearest the middle of the colon to reflect the tissue being taken of the same area. In FIG. 10, it can be seen that fecal specimens collected during necropsy were vastly different than those collected from a clean cage bottom. This result needs to be repeated but may indicate that there is differential production/utilization of dopamine along the intestinal tract.

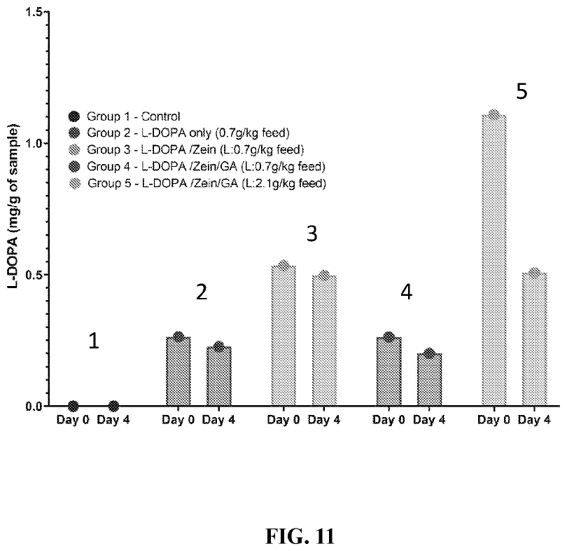

Upon receiving the feed before feeding, Groups 2, 4, and 5 had visible oxidation and were darker in color. Group 3 looked similar to the control feed and oxidation seemed to be less of an issue. In FIG. 11, the differences and degradation of L-DOPA can be seen between the groups. Group 3 started closest to the intended quantity of L-DOPA. Group 5 was projected to be fed 2.1 g/kg of feed but started at nearly half that amount and within 4 days that amount halved again. These are signs that there was additional oxidation in Group 5 while Group 3 had minimal degradation over the 4 days.

### Example 3

### In Vitro Testing

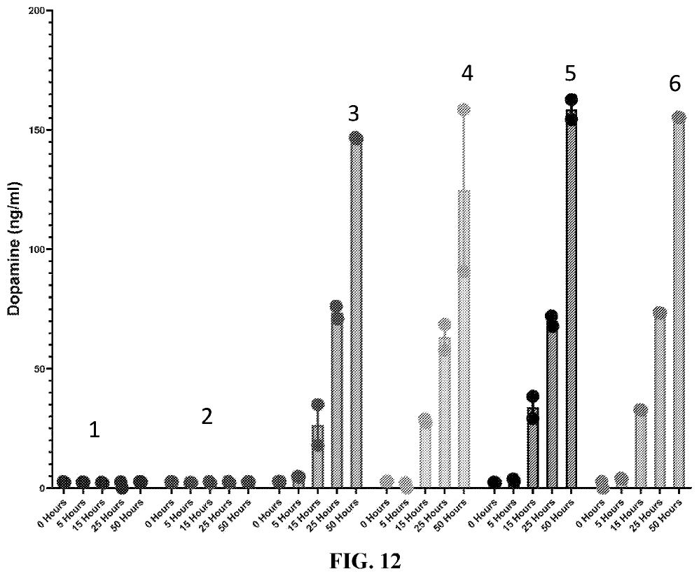

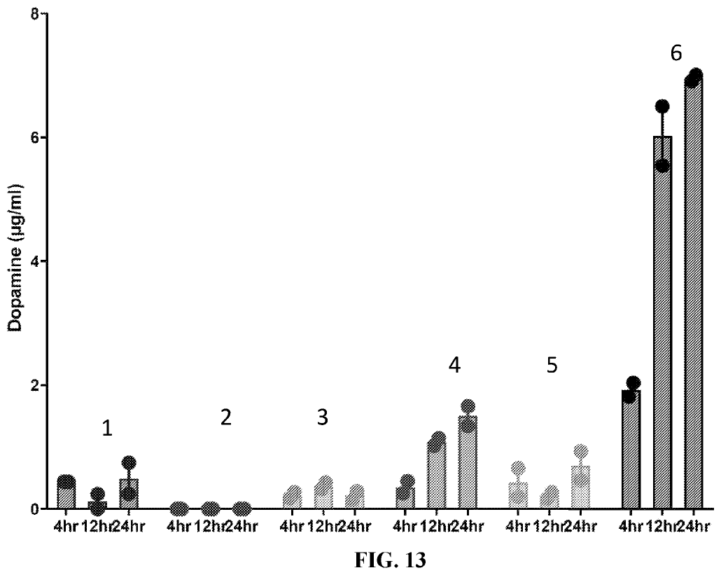

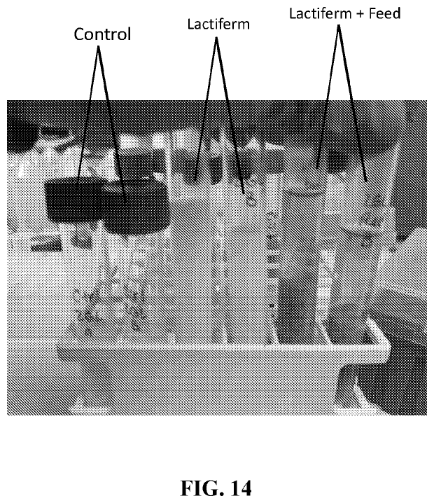

Analyses were completed before receiving animals. In vitro studies observed the bacteria's ability to digest through the zein protein and produce dopamine from the provided and protected L-DOPA. In vitro studies began with L-DOPA and zein before current distillation processes were instituted. In FIG. 12, there was 20% dopamine production over 50 hours. Gum Arabic was added to provide additional stability, and this was shown in solution. However, when feed was added to the vials of suspension, the solution containing gum Arabic appeared to have crashed out causing the gum Arabic to separate from the zein and L-DOPA. This can be seen in the photograph of FIG. 14. The vials present are those of a Zein-Gum Arabic-L-DOPA suspension. The control vials contain only suspension and no Enterococcus faecium (Lactiferm®), the solution is a creamy opaque appearance. The center vials contain Lactiferm® but no feed and maintain its creamy opaque appearance. The last vials contain Lactiferm® and feed. Once the feed was added the opacity immediately vanished leaving a nearly translucent solution that turned darker with oxidation over time. One evidence of this crash out effect is the greater amount of dopamine being produced in a short amount of time with these solutions as seen in FIG. 13. The cause for the rapid production is likely that the gum Arabic separated and left the L-DOPA more or less free in solution and easily digestible by the bacteria. This similar effect was seen during feed preparation when the gum Arabic containing solution was added to the feed, the feed began to increase in dark color and was darker upon feeding than the group 1, control, or group 3, zein/L-DOPA, feeds and can be reflected with the values shown in FIG. 11.

### Example 4

Additional testing to assess L-DOPA concentration and dopamine production using the compositions and methods described herein were conducted.

Zein protected L-DOPA suspensions were produced by adding L-DOPA dissolved in water to dissolved zein in an ethanol solution at various concentrations. It is well known that high concentrations of ethanol inactivate bacteria, therefore, removal to a suitable level is critical. As zein is insoluble in water, various stabilizers were added independently to create stable suspensions (e.g., gum Arabic, alginic acid). We determined that careful pH control is required for both suspension stability and L-DOPA oxidation prevention. Dilution of the zein/L-DOPA mixtures in water to ~5% ethanol and 5% zein did not practically influence E. faecium in TSB growth media.

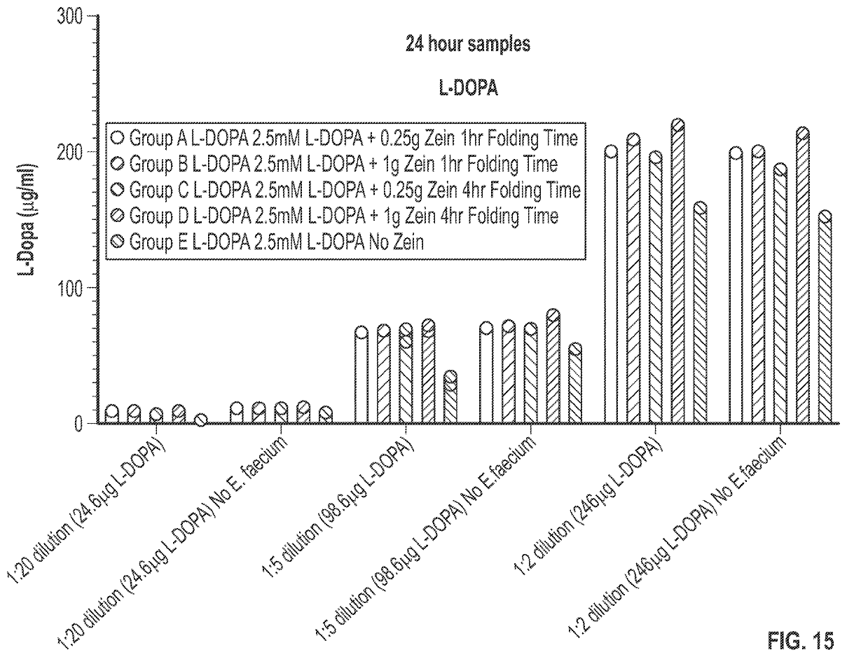

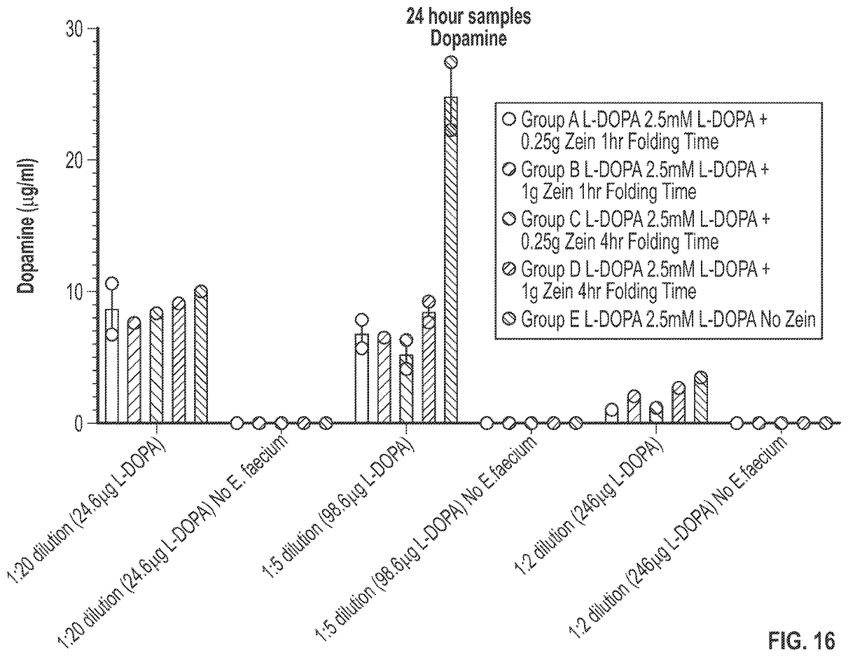

DOPA/zein solutions at different zein concentrations were diluted after specified mixing times then inoculated with E. faecium and sampled to quantify L-DOPA (shown in FIG. 15) and dopamine production (shown in FIG. 156. The mixing times and zein concentrations used did not dramatically change dopamine production at 24 hours suggesting little difference in bioavailability. The highest dilutions yielded more dopamine in zein solutions and no zein produced the highest amount of dopamine. We hypothesize that reduced kinetic availability in zein solutions could be due to particle agglomeration as higher dilutions increased dopamine production; this observation suggests the ability to kinetically control dopamine production. Although dopamine production is lower, zein is an important component as oxidized L-DOPA is toxic to animals and therefore, limiting its oxidation is critical.

### Example 5

Additional testing to demonstrate encapsulation of L-DOPA will be conducted. Zein will be extracted from a novel high protein dried distillers grains (DDG) to determine yield and function from a low cost zein source for comparison to commercial high purity sources. DDG will be suspended in 95% ethanol/water containing sodium bisulfite (0.5%) and sodium hydroxide (0.25%) solution and heated to 60° C. for two hours (starting parameters) to dissolve zein, then cooled and filtered to remove undissolved material. The extraction process will be optimized by changing the time and temperature and the solids content will be validated for the method and composition of zein forms determined via gel permeation chromatography. The dissolved zein solution will be diluted with water to 80% ethanol/water and L-DOPA added to different concentrations systematically to determine the encapsulation efficiency.

This direct approach will reduce the number of steps required to encapsulate L-DOPA with zein to minimize manufacturing costs. The encapsulation efficiency of each L-DOPA/zein combination will be determined by diluting with water to precipitate the zein and the aqueous L-DOPA concentration quantified. Encapsulation will be confirmed via changes in molecular interactions measured with vibrational (Infrared/Raman) spectroscopy. Zein encapsulation of the L-DOPA is anticipated to provide much needed protection from air oxidation which will be challenged with accelerated aging in an environmental chamber and quantified via LC-MS/MS. To ensure success and compare dopamine production efficiency, we will develop a zein encapsulated L-DOPA ingredient for integration into animal feed. Probiotic/L-DOPA synbiotic fortified animal feed will be manufactured in the laboratory for subsequent in-vitro digestion studies. As-received unfortified chicken feed will be size reduced via rotor-beater mill and physically blended with the zein encapsulated L-DOPA and E. faecium at different concentrations using a benchtop scale single screw extruder. This approach was selected due to the facile scale up for commercialization and ease of application in industrial settings.

### Example 6

Additional testing to develop stable coating formulations for accurate delivery of L-DOPA to chicken feed will be conducted. Dissolved solutions of L-DOPA/zein will be added dropwise to aqueous gum solutions (gum Arabic or xanthan gum) at different concentrations to form aqueous gum stabilized fortification solutions. Coating solution stability (shelf life) will be investigated as a function of time via ultraviolet visible and molecular interactions by vibrational spectroscopy (infrared/Raman). These solutions will be spray applied to animal feed using a traditional air assisted spray application as well as a commercially available electrostatic spray applicator then dried in an oven to simulate production. These application methods were selected due to their prevalence in industry for in-plant production and potential on-farm application. Coating coverage and film formation properties on the animal feed will be investigated using scanning confocal laser microscopy. Residual moisture and animal feed texture will be investigated to understand animal palatability and acceptability. Should these formulations not properly form films on the chicken feed, they will be reformulated with glycerol as this has been shown to facilitate film formation in the literature. Should this approach not successfully form coatings, this research will still facilitate zein based delivery system for L-DOPA as a food ingredient which can be formulated directly by feed manufacturers. This will ultimately increase protection of the L-DOPA during animal feed manufacturing.

### Example 7

In Vitro digestion investigation to understand bioavailability will be conducted. Each fortified animal feed formulation will be analyzed for bioavailability and production of dopamine via in vitro digestion studies. In brief, the zein-L-DOPA coated probiotic feed will be processed to mimic the three-stages of digestion in a chicken. There will be a salivary phase followed by a stomach and ultimately small intestinal phases to which the candidate feeds will be sequentially processed. This ultimately results in a simulated small intestinal medium (sSIM) that closely reflects the actual condition in the gut. This process was adapted from that employed in the pharmaceutical industry to evaluate the bioavailability of oral drugs. Once the sSIM has been obtained, the amount of dopamine produced will be measured using UHPLC. The amount of dopamine produced will be directly proportional to the amount of L-DOPA available and will demonstrate the degree of bioavailability of the L-DOPA zein feed. L-DOPA will also be quantified in coated chicken feed without the probiotic to understand L-DOPA availability during digestion.

### Example 8

Additional testing to identify key molecular structures of the protectant material zein and gum Arabic to identify alternatives were conducted.

L-DOPA and tyrosine have similar molecular structures and the higher tyrosine content in the protein increases L-DOPA solubility and protection from oxidation. Most proteins are soluble in ethanol solutions and often precipitate upon ethanol removal. During the ethanol removal process, the hydrophobic amino acid residues tend to fold inward creating a hydrophobic core hindering oxidative species from reaching the L-DOPA molecule. With the addition of aqueous L-DOPA solutions favorable interactions with the tyrosine residues are expected due to their similar molecular structures as shown in Tyrosine (left) and L-DOPA (right):

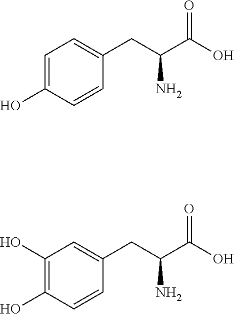 [SMILES: N[C@@H](Cc1ccc(O)cc1)C(=O)O ; N[C@@H](Cc1ccc(O)c(O)c1)C(=O)O]

Therefore, the protectant materials identified in addition to zein are selected based on the presence and absence of tyrosine residues. Zein (tyr=5.1 g/100 g) alternatives for evaluation as protectant materials include proteins with different amino acid profiles and tyrosine content soy protein (tyr=g/100 g), pea protein (tyr=3.8 g/100 g), gluten (tyr=2.5 g/100 g), poly(lactic-co-glycolic acid) (PLGA) (tyr=0 g/100 g), poly(N-vinylpyrrolidone) (tyr=0 g/100 g), casein (tyr=5.7 g/100 g), whey (tyr=3.3 g/100 g), bovine gelatin (tyr=0.22 g/100 g), and albumin for chicken egg white. Gum Arabic alternatives for evaluation as dispersants include smaller molecule surfactants (soy lecithin, glycerol monostearate, and Tween 80) and polymers/proteins such as chitosan, poly(alginic acid), gelatin, and block copolymers of poly (ethylene oxide) and poly (propylene oxide), and polyethylene.

For each formulation, 350 mg of L-DOPA was dissolved into 90 mls of water with a pH of 5 warmed to 50° C. Each protectant was dissolved, mixed thoroughly with the L-DOPA solution, and allowed to sit in solution for a minimum of 30 minutes. The dispersant was then added, thoroughly mixed and allowed to sit in solution for a minimum of 30 minutes before transferring to 3-necked round bottom flask for distillation as needed. Distillation required 1-2 hours per 100 mls of solution at 45° C. with continuous stirring. Recycled alcohol was saved after formulation making for reuse at a later time.

After distillation process, formulations were poured into small petri dishes placed on racks and placed into Harvest Right freeze drier for overnight drying process. The morning following the freeze drying, petri dishes were removed from the freeze drier and the dried contents transferred to a freezer bag with absorption pack to prevent condensation.

Preparation of each test combination was performed as follows:

### Zein+Gum Arabic

1.13 g of Zein was dissolved into 440 mls of 70% alcohol solution. 1.13 g of Gum Arabic was dissolved into 113 mls of 50° C. distilled water. Both solutions were separately allowed to spin and fully mix for 30 minutes. After solution set up time, the gum Arabic solution was slowly added to the spinning zein/l-dopa solution over 5 minutes time. Final solution was allowed to continue mixing over 30 minutes and then added to round bottom flask. Final solution was an opaque hay yellow color with the zein settling to the bottom of the solution if allowed to sit without mixing.

After freeze drying process, powders were transferred to freezer bag. Powders were hygroscopic and extremely light and easy to brush off out of petri dishes.

### Zein+Polyethylene

1.13 g of Zein was dissolved into 440 mls of 70% alcohol solution. 1.13 g of Polyethylene oxide was dissolved into 113 mls of 50° C. distilled water. Both solutions were separately allowed to spin and fully mix for 30 minutes. After solution set up time, the polyethylene oxide solution was slowly added to the spinning zein/l-dopa solution over 5 minutes time. Final solution was allowed to continue mixing over 30 minutes and then added to round bottom flask. Final solution was a slightly opaque yellow color with the darker yellow zein settling to the bottom of the solution if allowed to sit without mixing.

After freeze drying process, powders were transferred to freezer bag. Powder consistency was light and formed a powdered wafer. The transfer to the freezer bag was easy with the powder forming a semi-solid layer.

### Zein+Tween80

1.13 g of Zein was dissolved into 440 mls of 70% alcohol solution. 113 mls of Tween80 was slowly and directly added to the spinning zein/1-dopa solution over 5 minutes time. The mixing solution was used to fully wash out the thick, viscous liquid out of the graduated cylinder and into solution. Final solution was allowed to continue mixing over 30 minutes and then added to round bottom flask. Final solution was a slightly opaque yellow color with the darker yellow zein settling to the bottom of the solution if allowed to sit without mixing.

After the freeze drying process, the liquids remained extremely viscous and did not decrease in quantity. The liquids were transferred to a plastic jar with lid and placed into freezer.

### Zein+Tween80

The Zein+Tween80 preparation was repeated. 1.13 g of Zein was dissolved into 440 mls of 70% alcohol solution. 1.4 g of Tween80 was slowly and directly added to the spinning zein/1-dopa solution over 5 minutes time. The mixing solution was used to fully wash out the thick, viscous liquid out of the small weigh boat and into solution. Final solution was allowed to continue mixing over 30 minutes and then added to round bottom flask. Final solution was a opaque hay yellow color. Solution remained in suspension when mixing was discontinued.

After freeze drying process, the powder appeared to have dispersed in a chaotic fashion. What could be collected was placed into freezer bag and stored. Plates and surrounding area were cleaned of the remaining powder.

### Zein+Chitosan

1.13 g of Zein was dissolved into 440 mls of 70% alcohol solution. 1.13 g of Chitosan was dissolved into 150 mls of 50° C. 0.5M HCl/water solution. Both solutions were separately allowed to spin and fully mix for 30 minutes. After solution set up time, the Chitosan solution was slowly added to the spinning zein/l-dopa solution over 5 minutes time. Final solution was allowed to continue mixing over 30 minutes and then added to round bottom flask. Final solution was an opaque hay yellow color with the zein settling to the bottom of the solution if allowed to sit without mixing.

After freeze drying process, the solution was dried into a brownish colored, soft, flaky in the shape of a potato chip measuring approximately H centimeter in thickness. Extremely easy to handle and store.

### Zein+Alginic Acid

1.13 g of Zein was dissolved into 440 mls of 70% alcohol solution. 1.13 g of alginic acid was dissolved into 150 mls of 50° C. 2M sodium hydroxide/water solution. Both solutions were separately allowed to spin and fully mix for 30 minutes. After solution set up time, the alginic acid solution was slowly added to the spinning zein/l-dopa solution. The first milliliter of solution added caused the solution to turn a deep golden yellow color. As the zein/l-dopa solution continued to be added, the solution became increasingly darker in color. Once the entire amount of the alginic acid solution was added, the final solution was a dark brown color and the zein had appeared to crash out of solution leaving a great deal of precipitation floating. The solution was discarded and not remade due to the drastic color change and the crashing of the zein.

Gluten (from Wheat)+Gum Arabic

1.13 g of Gluten (from wheat) was dissolved into 440 mls of 70% alcohol solution. 1.13 g of Gum Arabic was dissolved into 113 mls of 50° C. distilled water. Both solutions were separately allowed to spin and fully mix for 30 minutes. After solution set up time, the gum arabic solution was slowly added to the spinning gluten/l-dopa solution over 5 minutes time. Final solution was allowed to continue mixing over 30 minutes and then added to round bottom flask. Final solution was a cloudy white color with the gluten settling to the bottom of the solution if allowed to sit without mixing.

After freeze drying process, powders were transferred to freezer bag. Powders were hygroscopic and extremely light and easy to brush off out of petri dishes.

### Casein+Gum Arabic

1.13 g of Casein was dissolved into 100 mls of 10 mM Calcium chloride. Once the casein was fully in solution, it was slowly added to 90 mls of L-DOPA solution, no alcohol was needed. 1.13 g of gum arabic was dissolved into 113 mls of 50° C. distilled water. Both solutions were separately allowed to spin and fully mix for 30 minutes. After solution set up time, the gum arabic solution was slowly added to the spinning casein/l-dopa solution over 5 minutes time. Final solution was allowed to continue mixing over 30 minutes and then added to round bottom flask. Final solution was a brownish opaque solution and would settle out of solution if not continuously mixing.

After freeze drying process, the solution was dried into a light tan color and the light, fluffy hygroscopic powder was transferred to freezer bag for storage. Transfer was difficult as there remained a thin layer of powder adhered to the petri dish and required being scrapped off in order to transfer.

### Whey+Gum Arabic

1.13 g of Whey was dissolved into 90 mls of L-DOPA solution, no alcohol was needed. 1.13 g of gum arabic was dissolved into 113 mls of 50° C. distilled water. Both solutions were separately allowed to spin and fully mix for 30 minutes. After solution set up time, the gum arabic solution was slowly added to the spinning whey/l-dopa solution over 5 minutes time. Final solution was allowed to continue mixing over 30 minutes and then added to round bottom flask. Final solution was an opaque white solution and would settle out of solution if mixing was not continued.

After freeze drying process, the solution was dried into a white fluffy powder and was transferred to freezer bag for storage. Transfer was difficult as there remained a thin layer of powder adhered to the petri dish and required being scrapped off in order to transfer.

### Gelatin+Gum Arabic

1.13 g of Gelatin (from bovine skin) was dissolved into 90 mls of L-DOPA solution, no alcohol was needed. 1.13 g of gum arabic was dissolved into 113 mls of 50° C. distilled water. Both solutions were separately allowed to spin and fully mix for 30 minutes. After solution set up time, the gum arabic solution was slowly added to the spinning gelatin/l-dopa solution over 5 minutes time. Final solution was allowed to continue mixing over 30 minutes and then added to round bottom flask. Final solution was a slightly opaque solution without color.

After freeze drying process, the solution was dried into a white layer roughly between ½ to 1 centimeter in thickness. The consistency was similar to Styrofoam and was easy to remove from petri dishes and transfer to freezer bags.

### Polyvinyl+Gum Arabic

1.13 g of Polyvinylpyrrolidone was dissolved into 90 mls of L-DOPA solution, no alcohol was needed. 1.13 g of gum arabic was dissolved into 113 mls of 50° C. distilled water. Both solutions were separately allowed to spin and fully mix for 30 minutes. After solution set up time, the gum arabic solution was slowly added to the spinning polyvinyl/l-dopa solution over 5 minutes time. Final solution was allowed to continue mixing over 30 minutes and then added to round bottom flask. Final solution was a slightly opaque colorless solution.

After freeze drying process, the solution was dried into a white, soft and fluffy layer similar to a cotton pad measuring approximately 12 centimeter in thickness. Extremely easy to handle and store.

### Soy Protein+Gum Arabic

1.13 g of Soy Protein was dissolved into 90 mls of L-DOPA solution, no alcohol was needed. 1.13 g of gum arabic was dissolved into 113 mls of 50° C. distilled water. Both solutions were separately allowed to spin and fully mix for 30 minutes. After solution set up time, the gum arabic solution was slowly added to the spinning soy protein/l-dopa solution over 5 minutes time. Final solution was allowed to continue mixing over 30 minutes, items were not vacuum distilled. Final solution was an opaque white solution and settled out to bottom of flask when not spinning.

After freeze drying process, the powder was dried into a light green, crunchy layer over powder that was hygroscopic and easy to transfer. The crunchy layer appeared to be a crust that was a darker layer resembling an almost burnt crust (the powder was freeze dried with pea protein and albumin and was definitely not burnt).

### Pea Protein+Gum Arabic

1.13 g of Pea Protein was dissolved into 90 mls of L-DOPA solution, no alcohol was needed. 1.13 g of gum arabic was dissolved into 113 mls of 50° C. distilled water. Both solutions were separately allowed to spin and fully mix for 30 minutes. After solution set up time, the gum arabic solution was slowly added to the spinning pea protein/l-dopa solution over 5 minutes time. Final solution was allowed to continue mixing over 30 minutes, items were not vacuum distilled. Final solution was an opaque tan/light brown color, solution settled out to bottom of flask when not spinning.

After freeze drying process, the powder was dried into a white powder that was hygroscopic and fluffy. Powder was easy to transfer through tapping of the bottom of the petri dish. However, it appeared that the solution settled at the bottom of the petri dish separate from the white, fluffy powder on the top.

### Albumin for Chicken Egg White+Gum Arabic

1.13 g of albumin for chicken egg white was dissolved into 90 mls of L-DOPA solution, no alcohol was needed. 1.13 g of gum arabic was dissolved into 113 mls of 50° C. distilled water. Both solutions were separately allowed to spin and fully mix for 30 minutes. After solution set up time, the gum arabic solution was slowly added to the spinning albumin/l-dopa solution over 5 minutes time. Final solution was allowed to continue mixing over 30 minutes and then added to round bottom flask. Final solution was an opaque whitish color. Solution did not settle out when spinning ceased.

After freeze drying process, the powder was dried into a white powder that was hygroscopic and fluffy.

### Oxidation Experiments

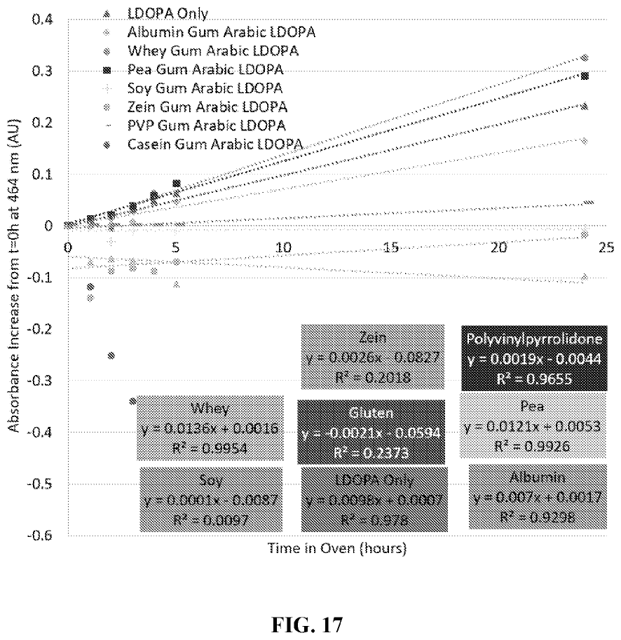

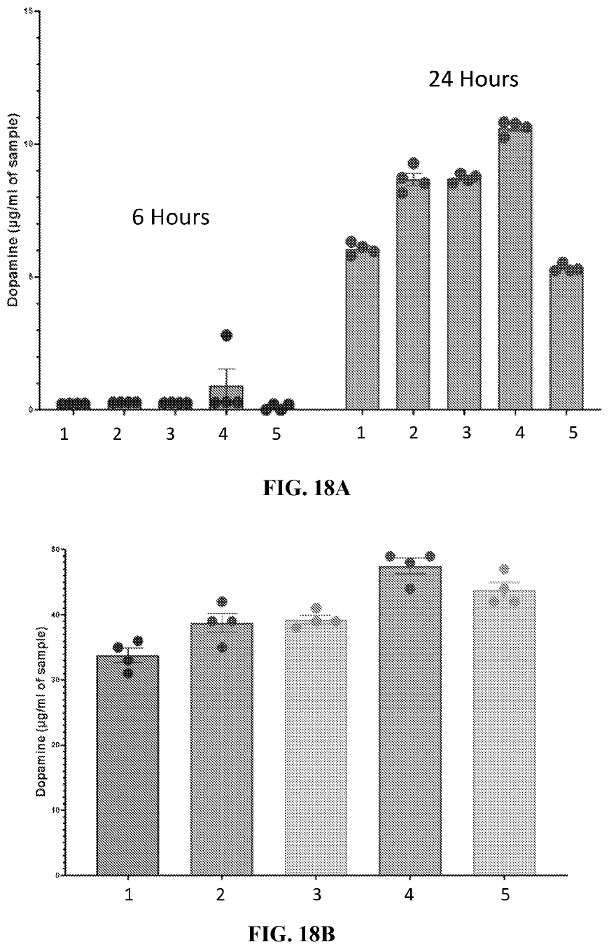

Following preparation of the test samples, oxidation experiments were conducted. 250 mg of the protectant/dispersant/L-DOPA combination was dispersed in 200 mL of water using a Kinematic Polytron PT 3100D with a “W” type dispersing aggregate for five minutes at 3,000 rpm. Approximately 1.5 mL of each solution were added to a polymethyl methacrylate cuvette and covered with parafilm M to minimize water loss during the oven conditioning. It should be noted that parafilm has a poor oxygen barrier which would be best representative of accelerated real-world conditions. Three cuvettes of each protectant/dispersant/LDOPA combination were placed in a holder then conditioned in convection oven at 40° C. for 24 hours. UV-Vis spectra were collected between 324 and 1100 nm at 0, 1, 2, 3, 4, 5, and 24 hours. Oxidation experiments using LDOPA only in water identified a lambda max at 464 nm which was used to monitor the oxidation rates of each system as a function of time. Under these conditions, the slope is related to the oxidation kinetics where a higher slope is indicative of higher oxidation rates. Results are shown in FIG. 17.

### Example 9

The ability of the zein alternative formulations from Example 8 to protect L-dopa in feed was examined.

To test the ability of the zein alternatives to protect L-dopa in the feed and allow for the production of dopamine in the chicken gut and extraintestinal sites. 55 Cornish Cross chicks (non-sexed) were obtained and began feeding of the 5 below diets on Day 2 post-hatch. The diets consisted of standard commercially obtained Purina Starter/Grower diet that was supplemented with the below additive as described for each group. Fecal samples were obtained on days 2, 8 and 14 and serum and tissues were collected at necropsy which occurred on Day 14. All biological samples were processed as per standard laboratory procedures.

Diets and their Compositions:
1) Control
   a. Normal feed—no L-DOPA added
2) L-DOPA+Zein+Gum Arabic Supplemented
   a. 0.1% L-DOPA—1.0 grams L-DOPA per kg of feed
   b. 3.22 Gram Zein per kg of feed or per gram of L-DOPA
   c. 3.22 Gram Gum Arabic per kg of feed or per gram of L-DOPA
3) L-DOPA+Soy Protein+Gum Arabic Supplemented
   a. 0.1% L-DOPA—1.0 grams L-DOPA per kg of feed
   b. 3.22 Gram Soy Protein per kg of feed or per gram of L-DOPA
   c. 3.22 Gram Gum Arabic per kg of feed or per gram of L-DOPA
4) L-DOPA+Polyvinylpyrrolidone+Gum Arabic Supplemented
   a. 0.1% L-DOPA—1.0 grams L-DOPA per kg of feed
   b. 3.22 Gram Polyvinylpyrrolidone per kg of feed or per gram of L-DOPA
   c. 3.22 Gram Gum Arabic per kg of feed or per gram of L-DOPA
5) L-DOPA+Casein+Gum Arabic Supplemented
   a. 0.1% L-DOPA—1.0 grams L-DOPA per kg of feed
   b. 3.22 Gram Casein per kg of feed or per gram of L-DOPA
   c. 3.22 Gram Gum Arabic per kg of feed or per gram of L-DOPA

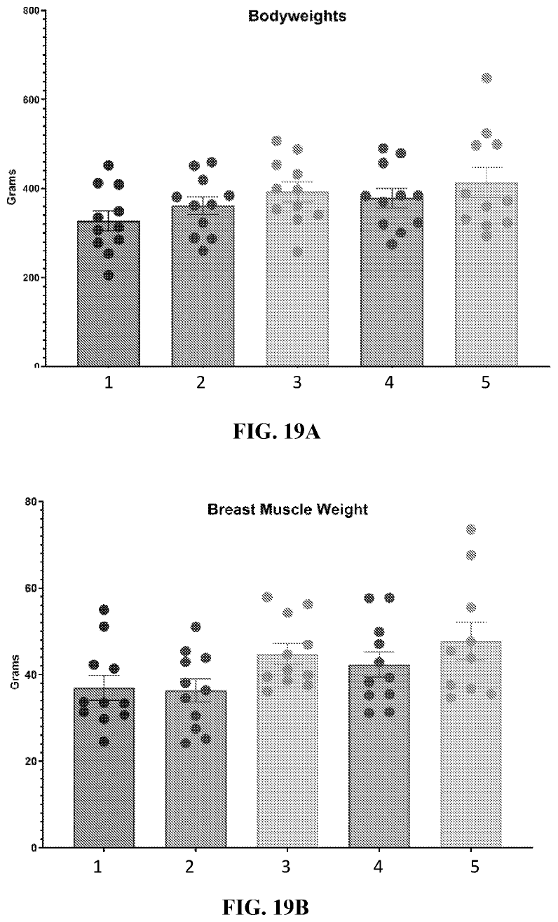

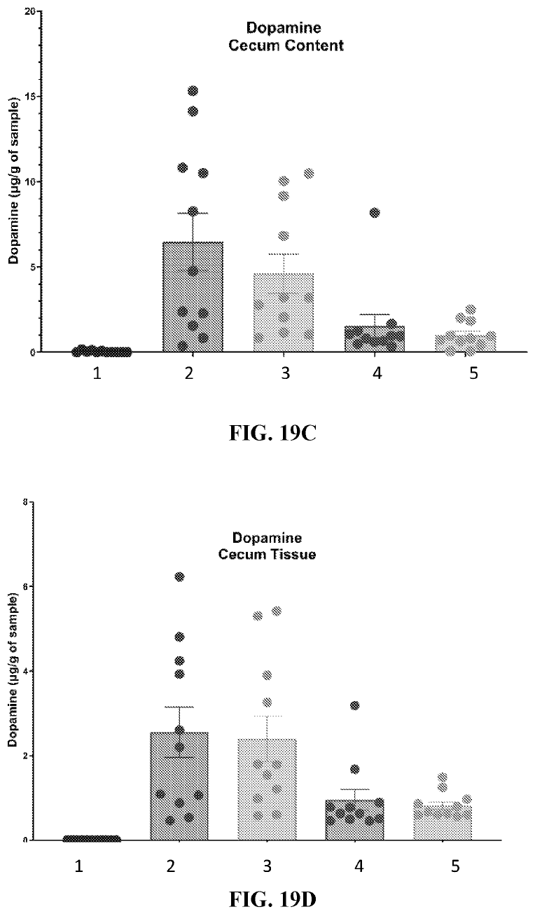

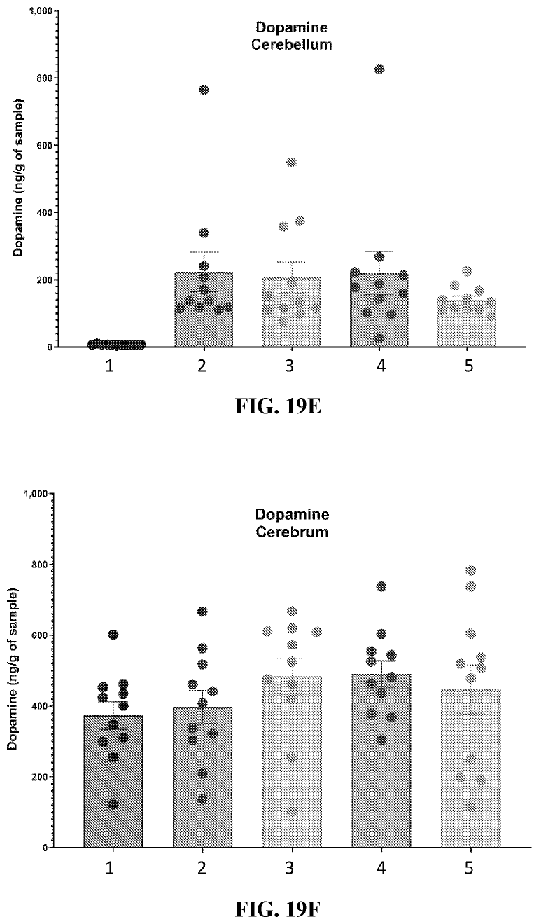

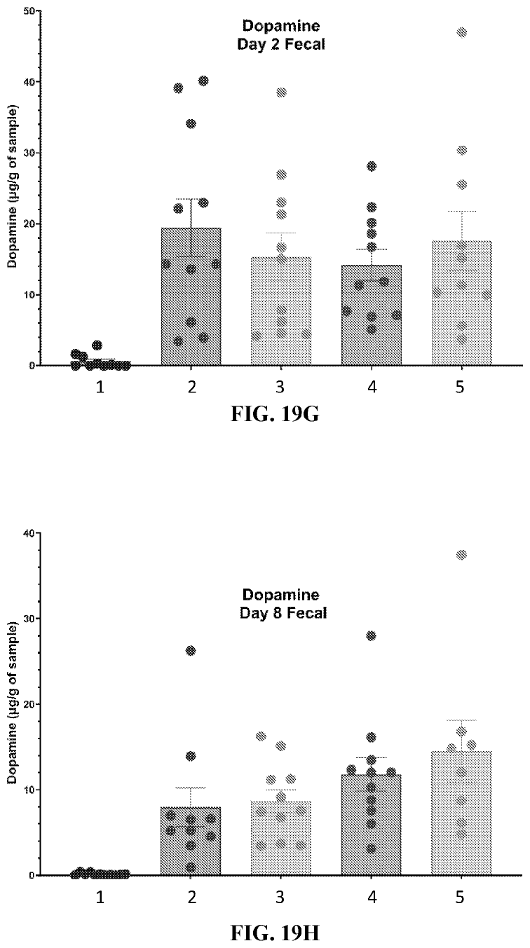

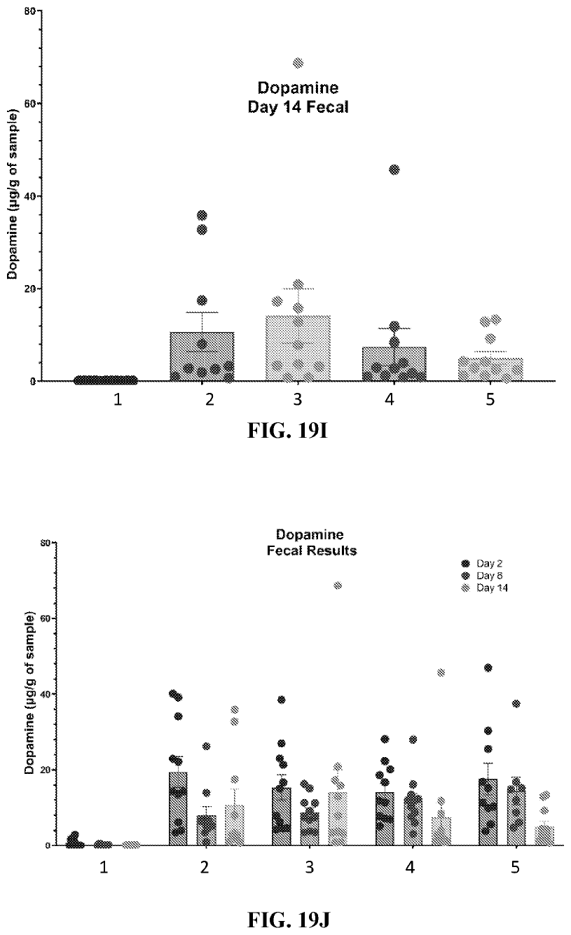

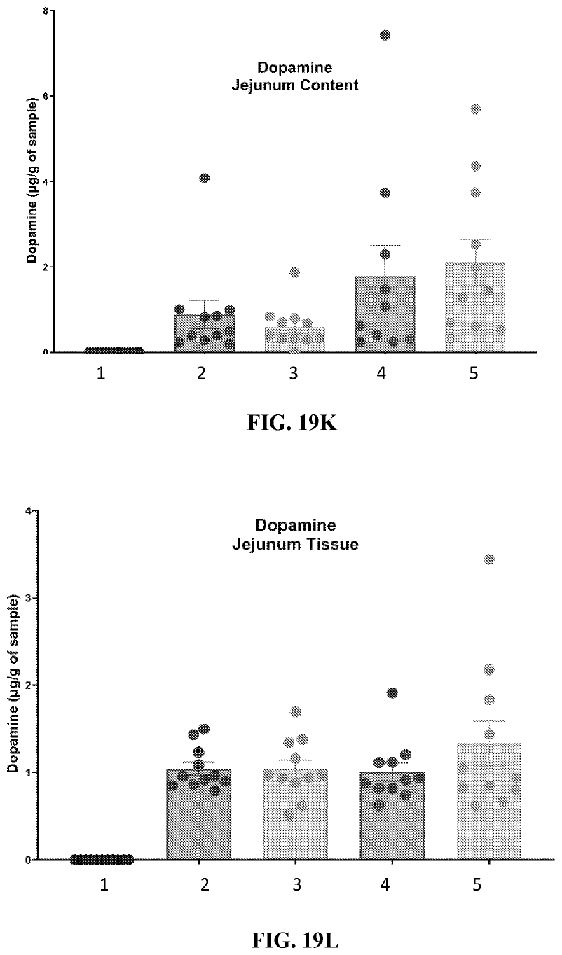

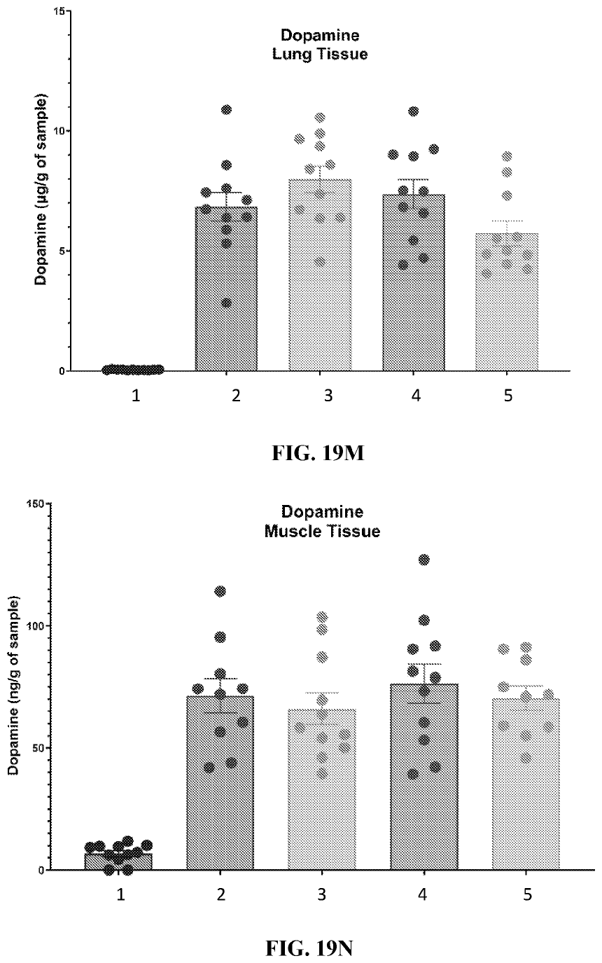

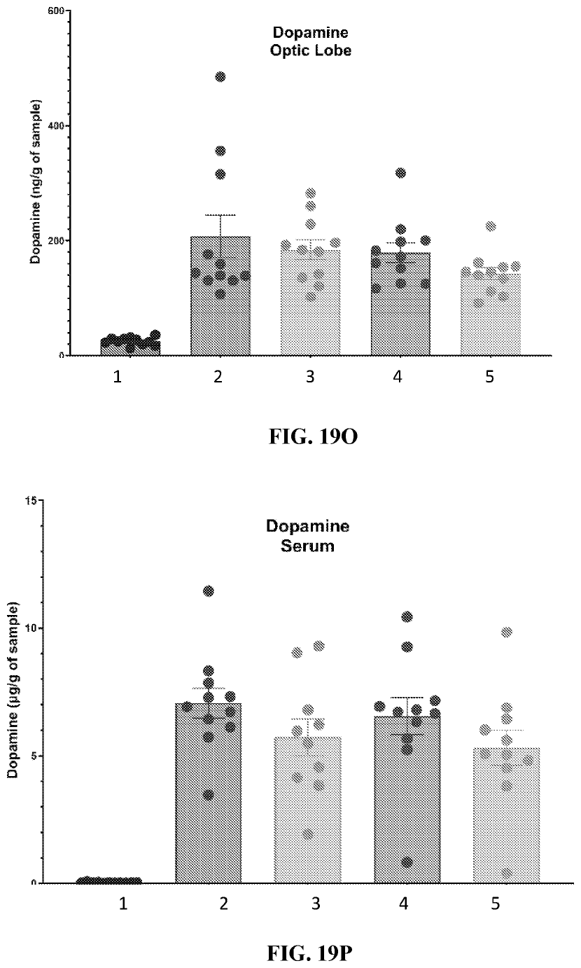

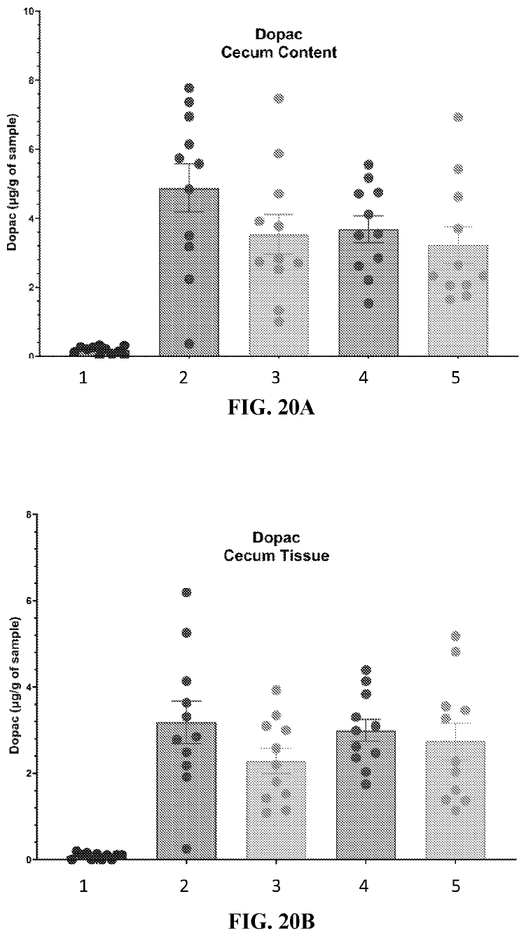

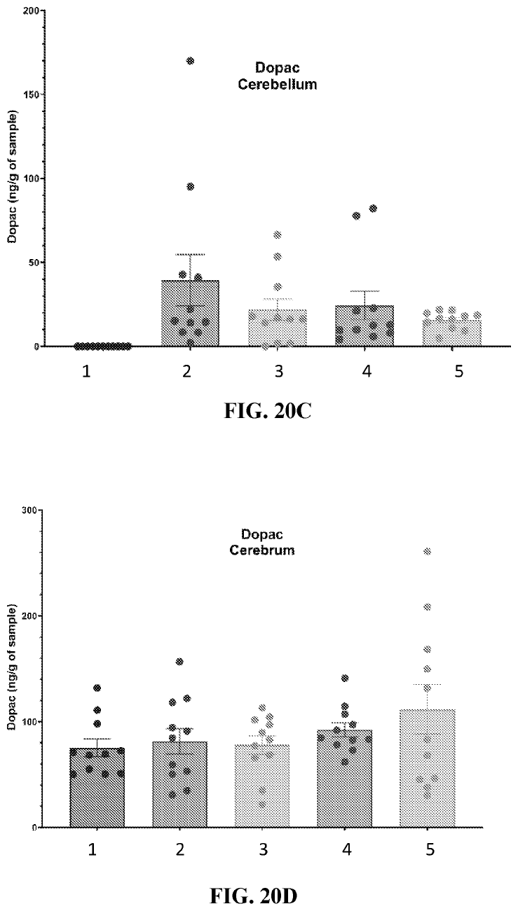

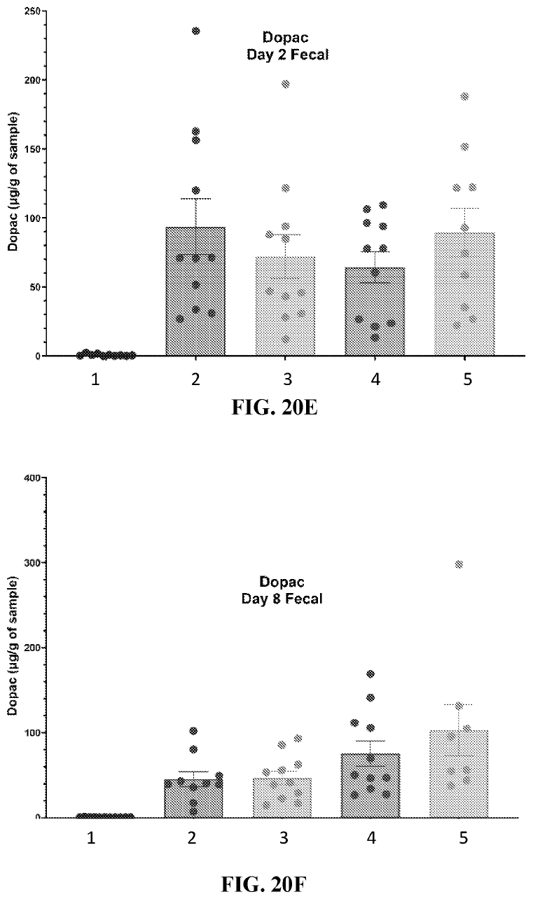

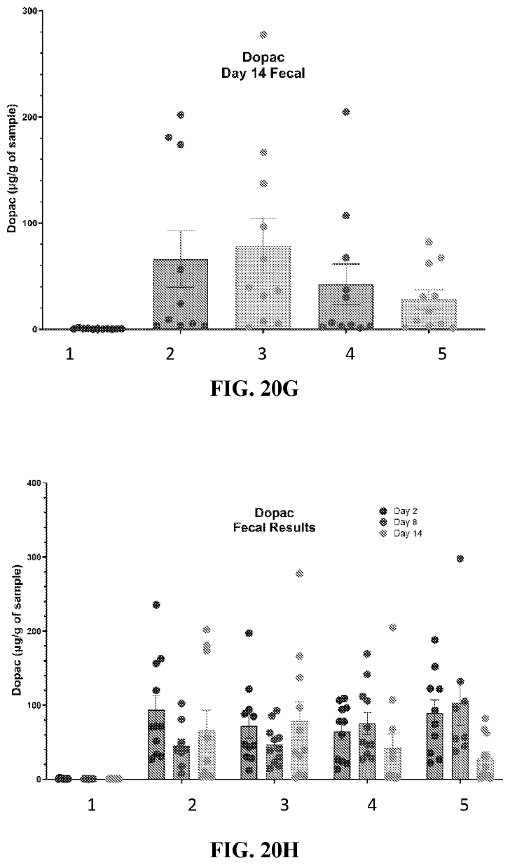

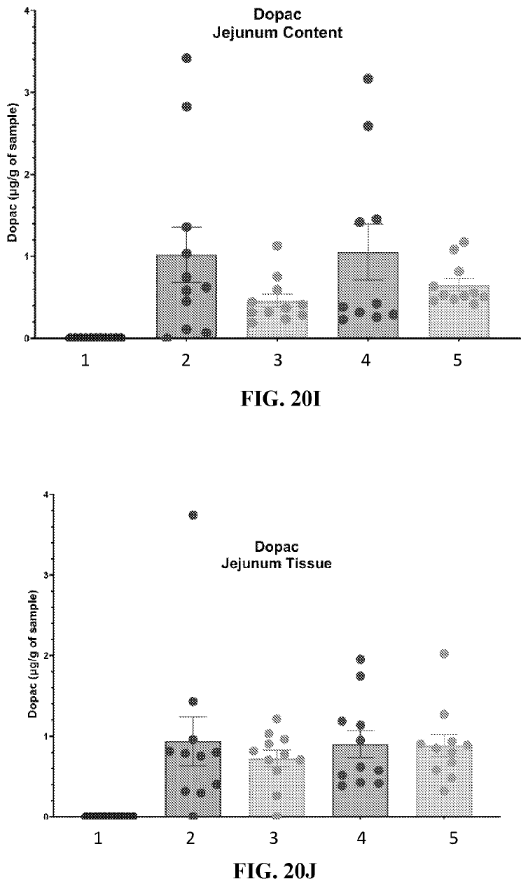

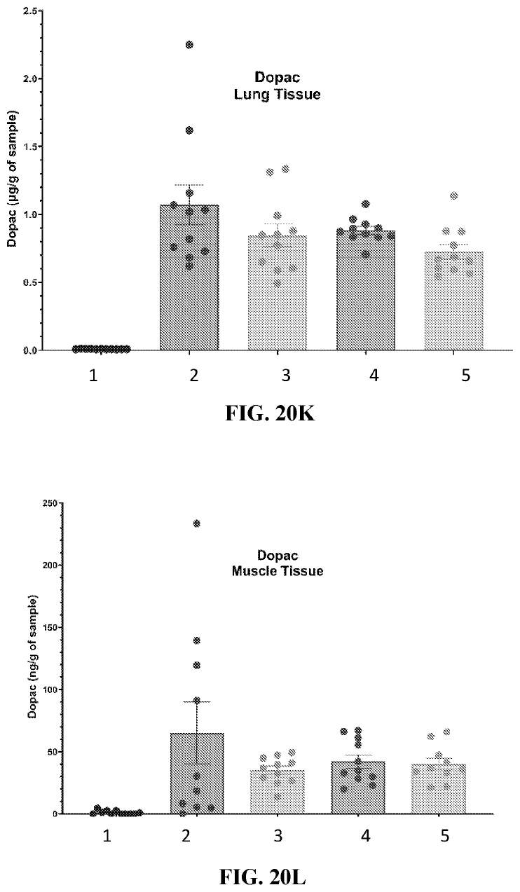

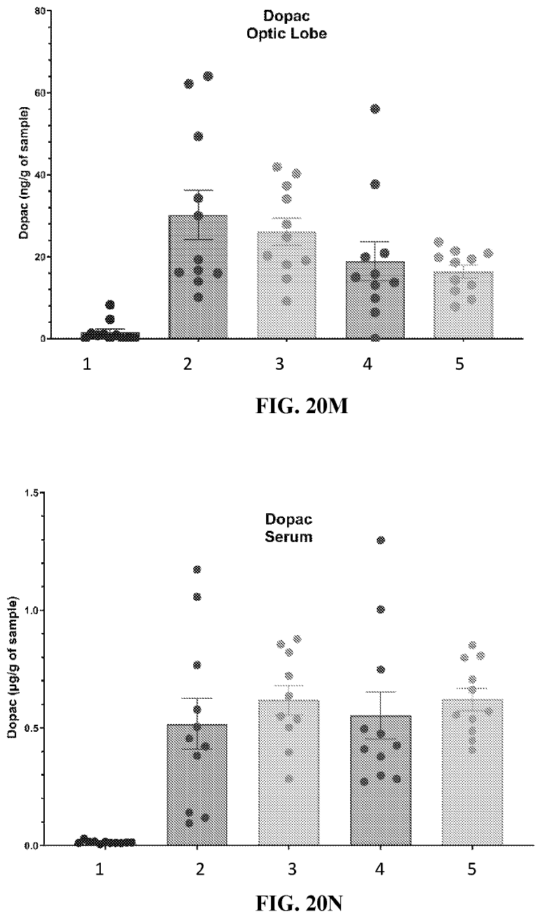

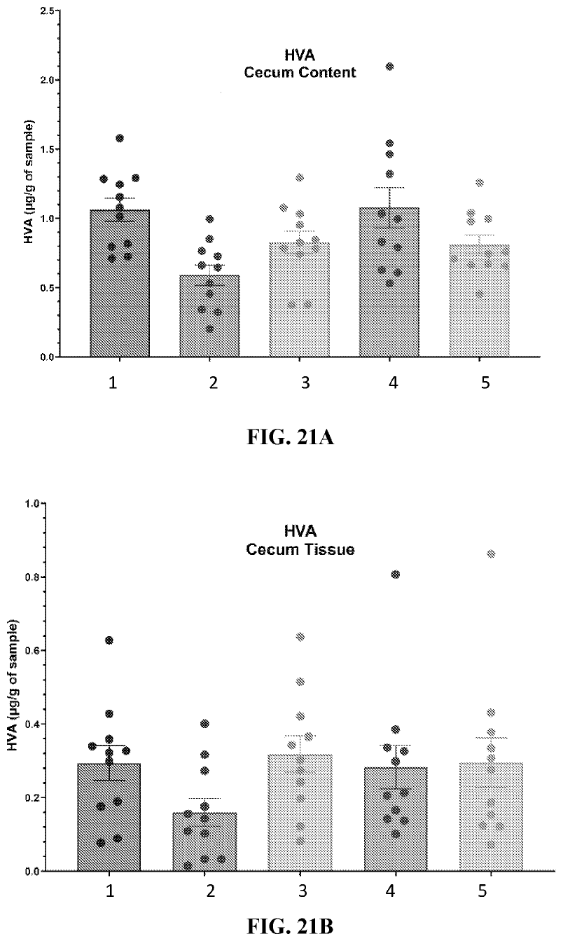

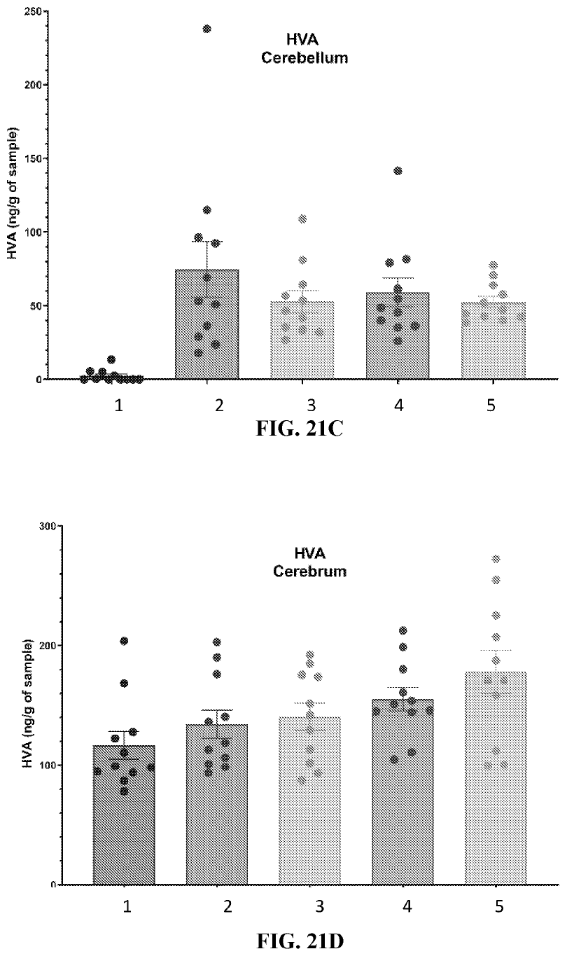

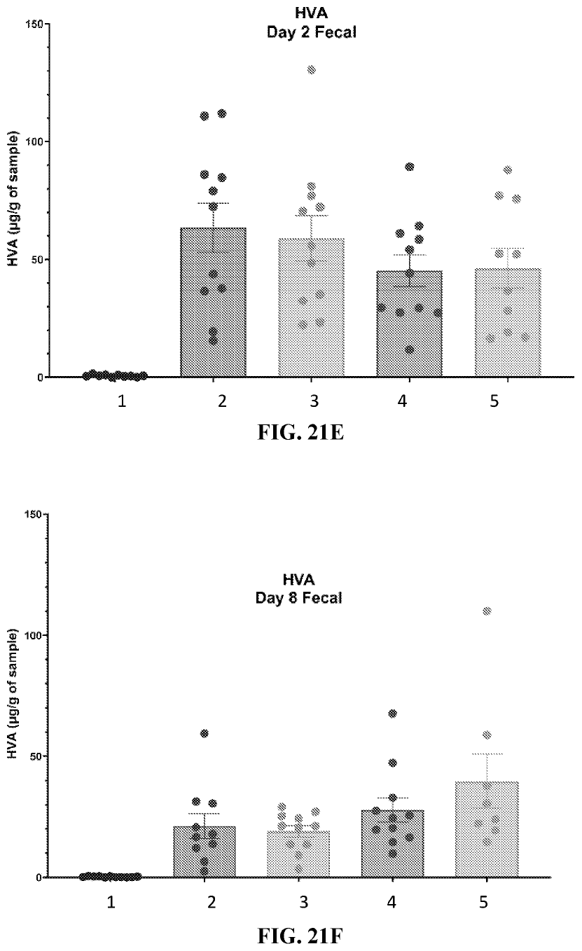

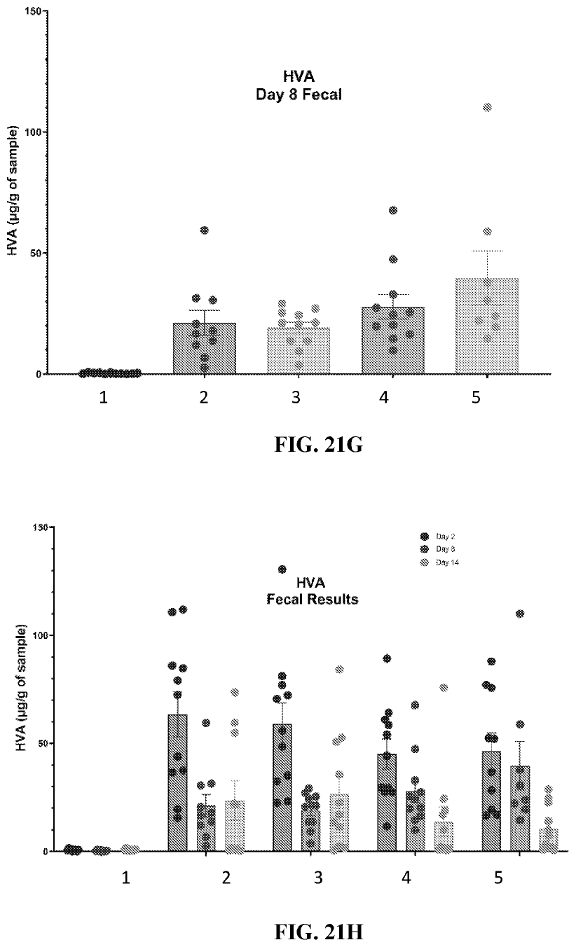

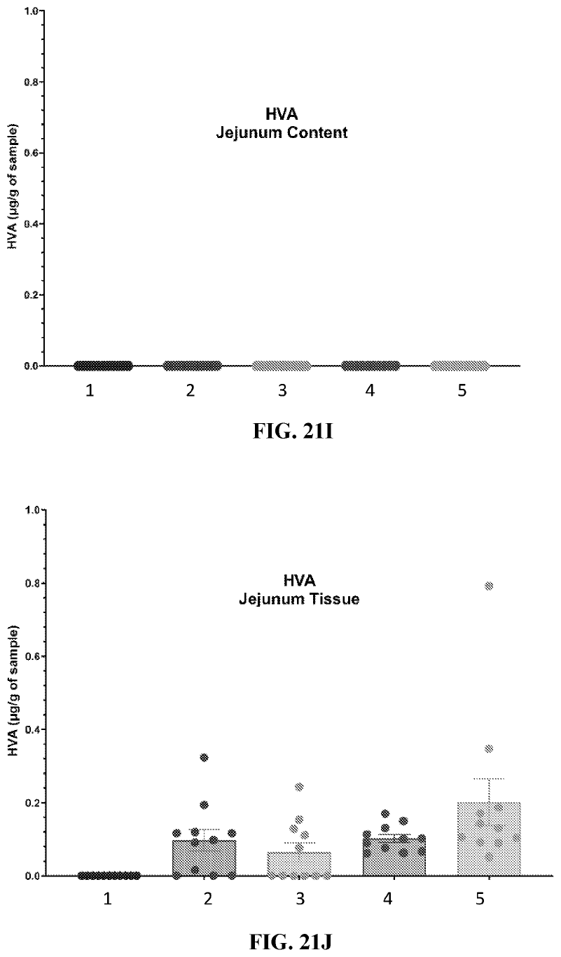

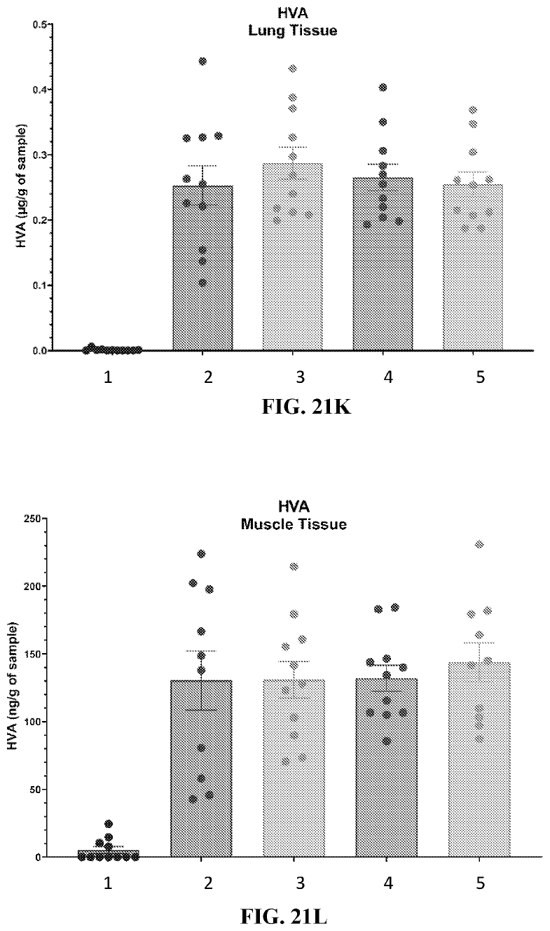

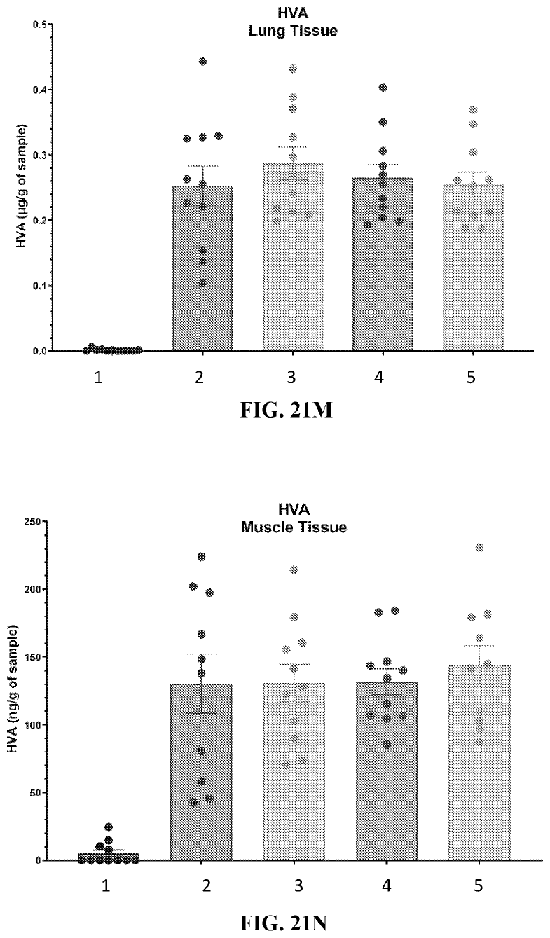

Results are shown in FIGS. 19-21, which present the concentration of dopamine and dopamine metabolites 3,4-Dihydroxyphenylacetic acid (DOPAC) and homovanillic acid (HVA) in the cecum, brain, feces, jejunum, lung, muscle, eye, and serum.

The results unequivocally demonstrate that feeding of the zein alternatives produced highly significant increases in dopamine not only in the gut but also in extraintestinal sites such as the lungs and the brain. The latter finding, of increased dopamine in the brain, is of particular interest as it can not only positively influence behavior but also that it is critical in the treatment of neurodegenerative diseases such as Parkinson's disease.

It should be noted that the graphs in FIGS. 19A and 19B are concerned with bodyweights and muscle weight. These were included as the ability to increase feed efficiency, and resultant weight gain, is the most important criteria for the animal food production industry. As shown in the graphs, as little as 2 weeks of feeding had increases in both weight and muscle weight that although slight, would be considered by the industry to be highly desirable since as little as 1% change is recognized to be a significant enough change to increase profitability. Further, the order of the graphs shows dopamine first, then DOPAC and HVA. The DOPAC and HVA represent two of the principal metabolites of dopamine and are further proof that dopamine was made in the biological samples shown in the graphs.

### Example 10

### Accelerated Aging Study to Determine L-DOPA Oxidation Potential and Shelf Stability

The L-DOPA formulations from Example 8 will be packaged in clear polyethylene packaging then subjected to accelerated aging conditions at different temperatures (room temperature to 60° C.) under different lighting conditions (no light, cool white fluorescence, and ultraviolet-A). These experiments will facilitate understanding of the degradation kinetics under aggressive storage conditions; polyethylene packaging does not significantly block degradative light wavelengths and is a poor oxygen barrier. L-DOPA oxidation will be quantified via ultra-high performance liquid chromatography (UHPLC).

### In Vitro and In Vivo Digestion

Each liquid formulation will be analyzed for bioavailability and production of dopamine via in vitro digestion. The fortified feed will be processed to mimic the three sequential stages of digestion in a chicken: salivary, stomach, and small intestinal phases. This ultimately results in a simulated small intestinal medium (sSIM) that closely reflects the actual condition in the gut. The amount of dopamine produced will be measured using UHPLC which is directly proportional to the amount of bioavailability L-DOPA in the L-DOPA zein feed.

It is to be understood that while the invention has been described in conjunction with the detailed description thereof, the foregoing description is intended to illustrate, and not limit the scope of the invention, which is defined by the scope of the appended claims. Other embodiments, advantages, and modifications are within the scope of the following claims. Any reference to accompanying drawings which form a part hereof, are shown, by way of illustration only. It is understood that other embodiments may be utilized and structural changes may be made without departing from the scope of the present disclosure. All publications discussed and/or referenced herein are incorporated herein in their entirety.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof

What is claimed is:

1. A composition comprising:
a stable protected prebiotic comprising a prebiotic dopamine precursor and/or a co-factor of dopamine; and
a protectant material comprising zein, a natural or synthetic protein comprising tyrosine, a natural or synthetic polymer comprising tyrosine, and/or other natural or synthetic monomers with similar structures to tyrosine;
wherein the composition is a prebiotic delivery system that fortifies a feed, food or water source for digestion activation of the dopamine precursor and/or co-factor of dopamine.

2. The composition of claim 1, wherein the prebiotic dopamine precursor is L-DOPA.

3. The composition of claim 2, wherein the L-DOPA can be provided as an herbal or plant source, optionally a genetically engineered L-DOPA producing plant or microbe, or commercially available substance procured as a purified or unpurified substance.

4. The composition of claim 3, wherein the L-DOPA producing plant is Vicia faba or Mucuna pruriens, or wherein the genetically engineered L-DOPA producing plant is of the genus Nicotiana or a Solanum lycopersicum plant.

5. The composition of claim 1, wherein the co-factor of dopamine is pyridoxal phosphate.

6. The composition of any one of claims 1-5, wherein the protectant material encapsulates, coats, or otherwise prevents degradation of the prebiotic dopamine precursor and/or co-factor of dopamine until digestion activation.

7. The composition of any one of claims 1-5, further comprising a dispersant.

8. The composition of claim 7, wherein the dispersant comprises a natural polymer, synthetic polymer, gum, glycerol, food grade surfactant, or combinations thereof.

9. The composition of claim 8, wherein the gum comprises gum Arabic and/or xanthan gum.

10. The composition of claim 8, wherein the food grade surfactant comprises a nonionic surfactant.

11. The composition of claim 10, wherein the nonionic surfactant comprises Tween, Tween-80, a polyethoxylated surfactant, or combinations thereof.

12. The composition of claim 8, wherein the natural polymer comprises chitosan and/or alginic acid.

13. The composition of claim 8, wherein the synthetic polymer comprises polyethylene oxide.

14. The composition of any one of claims 1-5, wherein the prebiotic dopamine precursor and/or co-factor of dopamine is provided in a therapeutically effective amount of from about 0.1 mg/g to about 10 mg/g, from about 0.1 mg/kg to about 10 mg/kg, from about 0.1 mg/ton to about 10 mg/ton, or volumetric equivalent, based on the weight of the feed, food, or water source.

15. The composition of any one of claims 1-5, wherein the protectant material is a plant protein zein, optionally wherein the plant protein zein is derived from dried distillers grain (DDG) or from corn endosperm.

16. The composition of any one of claim 1-5, wherein the natural or synthetic protein comprising tyrosine is casein, gluten, whey, gelatin, soy protein, pea protein, and/or albumin.

17. The composition of any one of claims 1-5, wherein the composition is a solid or liquid dosage form.

18. A method of delivering a fortified feed, food or water source comprising:
combining the composition according to any one of claims 1-5 with a feed, food, or water source to provide a fortified feed, food, or water source; and
administering to a subject the fortified feed, food, or water source;
wherein the composition prevents oxidation of the prebiotic dopamine precursor and/or a co-factor of dopamine prior to delivery into a gut of the subject.

19. The method of claim 18, wherein the composition further comprises at least one probiotic.

20. The method of claim 19, wherein the composition maintains prebiotic and probiotic separation until digestion induced activation upon consumption.

21. The method of claim 18, wherein the subject is a human, animal or fish species.

22. The method of claim 18, wherein the subject is in need of treatment and/or prevention of inflammation, inflammatory disease states, and/or for improved gut health.

23. The method of claim 18, wherein the composition comprises a therapeutically effective amount of the prebiotic dopamine precursor and/or a co-factor of dopamine from about 0.1 mg/g to about 10 mg/g, from about 0.1 mg/kg to about 10 mg/kg, from about 0.1 mg/ton to about 10 mg/ton, or volumetric equivalent, based on the weight of the feed, food or water source.

24. The method of claim 18, wherein there is no more than about 10% oxidation of the prebiotic dopamine precursor and/or a co-factor of dopamine until delivery into the gut of the subject.

25. The method of claim 19, wherein the probiotic is at least one probiotic bacterial strain comprising an Enterococcus spp. and/or Vagococcus spp., and wherein a therapeutically effective amount of the probiotic strain(s) is from about 10⁴ CFU to about 10¹⁴ CFU based on the weight (CFU/g, CFU/kg, or CFU/ton) or volumetric equivalent of a feed, food or water source.

26. The method of claim 25, wherein the Enterococcus spp. comprises F faecium.

27. The method of claim 18, wherein the method is antibiotic-free.

28. The method of claim 18, wherein combining the composition and the feed, food or water source is by spraying the composition as a solid or a liquid solution onto the feed, food or water source.

29. The method of claim 28, further comprising drying the sprayed feed or food source.

30. A method of treating a subject in need of treatment and/or prevention of inflammation, inflammatory disease states, and/or for improved gut health comprising:
administering to a subject a therapeutically effective amount of the composition according to any one of claims 1-5 in combination with a feed, food or water source,
wherein the composition protects the prebiotic dopamine precursor and/or a co-factor of dopamine from oxidation prior to delivery into a gut of the subject.

31. The method of claim 30, wherein the composition further comprises at least one probiotic.

32. The method of claim 31, wherein the composition maintains prebiotic and probiotic separation until digestion induced activation upon consumption.

33. The method of claim 30, wherein the subject produces biological levels of dopamine to reduce inflammation, treat inflammatory disease states and/or improve gut health.

34. The method of claim 30, wherein a subject treated with the composition has an increased body weight and/or muscle weight as compared to a subject not treated with the composition.

35. The method of claim 30, wherein the subject is a human, animal or fish species.

36. The method of claim 31, wherein the animal species is poultry, pig or other food production animal, or wherein the fish species is any food aquaculture.

37. A method of treatment of a psychological disorder and/or a neurodegenerative disease in a subject in need thereof, comprising:
administering to a subject a therapeutically effective amount of the composition according to any one of claims 1-5 in combination with a feed, food or water source,
wherein the composition protects the prebiotic dopamine precursor and/or a co-factor of dopamine from oxidation prior to delivery into a gut of the subject.

38. The method of claim 37, wherein the composition further comprises at least one probiotic.

39. The method of claim 38, wherein the composition maintains prebiotic and probiotic separation until digestion induced activation upon consumption.

40. The method of claim 37, wherein the psychological disorder is anxiety, depression, attention-deficit/hyperactivity disorder (ADHD), addiction, schizophrenia, and/or stress.

41. The method of claim 37, wherein the neurodegenerative disease is Parkinson disease, Huntington disease, or Multiple Sclerosis.

42. A method of making a stable protected prebiotic composition, comprising:
combining a prebiotic dopamine precursor and/or a co-factor of dopamine and a protectant material to form a stable protected prebiotic,
wherein the protectant material comprises zein, a natural or synthetic protein comprising tyrosine, a natural or synthetic polymer comprising tyrosine, and/or other natural or synthetic monomers with similar structure to tyrosine, and
wherein the stable protected prebiotic composition is a liquid.

43. The method of claim 42, wherein the combining is in an ethanol/aqueous solution.

44. The method of claim 42, wherein the liquid stable protected prebiotic is spray dried.

45. The method of claim 42, wherein the prebiotic dopamine precursor is L-DOPA.

46. The method of any one of claims 42-45, wherein the composition further comprises a dispersant.

47. The method of claim 46, wherein the dispersant comprises a natural polymer, synthetic polymer, gum, glycerol, food grade surfactant, or combinations thereof.

48. The method of claim 47, wherein the gum comprises gum Arabic and/or xanthan gum.

49. The method of claim 47, wherein the food grade surfactant comprises a nonionic surfactant.

50. The method of claim 49, wherein the nonionic surfactant comprises Tween, Tween-80, a polyethoxylated surfactant, or combinations thereof.

51. The method of claim 47, wherein the natural polymer comprises chitosan and/or alginic acid.

52. The method of claim 47, wherein the synthetic polymer comprises polyethylene oxide.
